(19) United States
(12) Patent Application Publication
(10) Pub. No.: US 2009/0218548 A1
(43) Pub. Date: Sep. 3, 2009

(54) Electroconductive polymer material, producing method of electroconductive polymer material and electrode material

(75) Inventors: Takashi Kato, Kanagawa (JP); Hiroshi Miyachi, Kanagawa (JP)

Correspondence Address: Moss & Burke, PLLC, 401 Holland Lane, Suite 407, Alexandria, VA, 22314, US

(73) Assignee: FUJIFILM CORPORATION, Minato-ku (JP)

(21) Appl. No.: 12/379,493

(22) Filed: Feb. 24, 2009

(30) Foreign Application Priority Data
Feb. 29, 2008 (JP) 2008-051324

(51) Int. Cl. H01B 1/12

(52) U.S. Cl. 252/500

(57) ABSTRACT

An electro-conductive polymer material of the present invention is formed by forming a at least one layer 20 containing an electro-conductive polymer and a at least one layer 30 containing at least one selected from an acidic compound or reducing agent on or above a support 10. The electro-conductive polymer is preferably polythiophene or a derivative thereof, poly(3,4-ethylenedioxy)thiophene being particularly preferred. The layer 20 containing the electro-conductive polymer preferably contains polystyrene sulfonic acid. The acidic compound or reducing agent is preferably polyphosphoric acid, a hydroxy compound, a carboxy compound, a sulfonic acid compound, a thioether compound, a succinimide compound, a polyol compound, a hydroxamic acid compound or a hydroxyamine compound.

### CROSS REFERENCE TO RELATED APPLICATIONS

This application claims priority under 35 USC 119 from Japanese Patent Application No. 2008-051324, the disclosure of which is incorporated herein by reference.

### BACKGROUND OF THE INVENTION

1. Field of the Invention

The present invention relates to an electro-conductive polymer material, a producing method of the electro-conductive polymer material, and an electrode material.

2. Description of the Related Art

In recent years, displays typified by liquid crystal displays (LCD), plasma display panels (PDP), electroluminescence (EL) devices, or the like have increasingly been used widely in various fields such as television sets, computers and various types of mobile instruments which have recently been spreading increasingly, and are undergoing remarkable development. On the other hand, solar batteries are attracting attention as one of the non-fossil energies which pay consideration to the global environment. In order to address the need for further spread of solar batteries, research for improving the functions thereof and the like has been demanded. In such display devices and solar batteries, electro-conductive films are used.

Generally, electro-conductive films using metallic materials, such as ITO-based electro-conductive films, are produced by forming, on a glass substrate, a film from a metallic material by a vapor phase method such as a vacuum deposition method or a sputtering method. Display devices of cellular phones and mobile instruments have been becoming lighter in weight, and it has been demanded that display device substrates be shifted from glass to plastic. The introduction of plastic substrates has reduced the weight of display devices to half or less in comparison to conventional products, and the strength and the impact resistance have been increased remarkably.

There, however, is a problem with ITO-based electro-conductive films in that the substitution of glass substrates with plastic films results in a decrease in adhesiveness, making a substrate and a formed electro-conductive film prone to separate from each other. Moreover, metallic materials, such as ITO, require the use of an expensive production apparatus because they are formed into a film by using a vapor phase method such as sputtering.

Electro-conductive polymers are known as an electro-conductive material which substitutes for such conventional materials. The use of an electro-conductive polymer makes it possible to form a thin film which exhibits develop electric conductivity by coating, resulting in an advantage that such a film may be produced at low cost. Moreover, an electrode made of an electro-conductive polymer is more flexible and less brittle than ITO electrodes, and it therefore is less prone to break even if it is used in flexible items. For this reason, it also has an advantage that it may extend the life of devices if an electrode made of an electro-conductive polymer is used in a touch screen, which requires a particularly highly flexible electrode.

As such an electro-conductive polymer, a polythiophene containing a polyanion has been developed, and a technique of forming a thin film by using this polymer is disclosed in the specification of European Patent No. 440957. It, however, has become clear that this electro-conductive film is slightly weaker in durability than ITO films and the like and that it may not achieve a durability sufficient for practical use in some applications.

Meanwhile, a technology where polyethylene glycol is added to polythiophene in order to obtain an electro-conductive film excellent in the transparency as well as electroconductivity is proposed in Japanese Patent Application Laid-Open (JP-A) No. 2006-282942. However, in this technology, it was found that while the transparency and electroconductivity of an electro-conductive film immediately after production are improved, the transparency and electroconductivity after light is irradiated to some extent or more are deteriorated. When the electro-conductive film is applied to display devices, the photo-durability is very important.

On the other hand, an electro-conductive film in which polyphosphoric acid and a specified phenolic compound have been added to polythiophene has been proposed in Japanese Patent Application Laid-Open (JP-A) No. 2006-505099. This document discloses that the addition of polyphosphoric acid, or the like increases the photo-durability, that is, the increase in surface resistivity upon exposure to light is inhibited.

### SUMMARY OF THE INVENTION

According to a first aspect of the present invention, there is provided an electro-conductive polymer material, having: a support; at least one layer containing an electro-conductive polymer; and at least one layer containing at least one selected from an acidic compound or a reducing agent,

wherein the at least one layer containing an electro-conductive polymer and the at least one layer containing at least one selected from an acidic compound or a reducing agent are formed on or above the support.

According to a second aspect of the present invention, there is provided an electrode material having the electro-conductive polymer material according to the first aspect.

According to a third aspect of the present invention, there is provided a producing method of an electro-conductive polymer material according to the first aspect, in which at least two layers among the layer(s) containing an electro-conductive polymer and the layer(s) containing at least one selected from an acidic compound or a reducing agent are formed by simultaneous multilayer coating.

### BRIEF DESCRIPTION OF THE DRAWING

FIGS. 1A through 1D are sectional schematic views showing an example of a layer structure of an electro-conductive polymer material of the present invention.

### DETAILED DESCRIPTION OF THE INVENTION

It became obvious that, according to a technology of the JP-A No. 2006-505099, while the photo-durability is certainly improved, when an electro-conductive polymer such as polythiophene and polyphosphoric acid or a specified phenol compound are mixed, the electro-conductive polymer aggregates in some cases and thereby it is difficult to obtain a uniform film. It has been found that this aggregation also leads to a decrease in transparency of the electro-conductive film and also to a increase in surface resistivity of the film immediately after the formation thereof.

In view of the above circumstances, the present inventors researched extensively to overcome the problems and found that, when an acidic compound such as polyphosphoric acid or a specified phenol compound is added to a solution containing an electro-conductive polymer such as specified polythiophene, the electro-conductive polymer aggregates, and when an acidic compound and/or a reducing agent is added to a different layer from a layer containing an electro-conductive polymer, the photo-durability is improved. After more research based on the findings, the present invention was accomplished.

In the present invention, the “photo-durability” means variations of the transmittance and surface resistivity when outdoor light or a light source such as a xenon lamp light source is irradiated for a definite time. The smaller the variations of the transmittance and surface resistivity are, the more excellent the photo-durability is.

According to the present invention, an electro-conductive polymer material, a producing method of the electro-conductive polymer material, and an electrode material excellent in the photo-durability, transparency, electroconductivity and haze are provided.

The present invention will be described in detail below. In the present specification “ . . . ” to “ . . . ” represents a range including the numeral values represented before and after “to” as a minimum value and a maximum value, respectively.

<Electro-Conductive Polymer Material>

An electro-conductive polymer material of the present invention includes at least (1) a support, (2) a layer containing an electro-conductive polymer (hereinafter, in some cases, referred to as “electro-conductive polymer layer”), and (3) a layer containing at least one selected from an acidic compound or a reducing agent (hereinafter, in some cases, referred to as “doped state stabilization layer”). The (2) layer containing an electro-conductive polymer and the (3) layer containing at least one selected from an acidic compound or reducing agent being laminated on or above the (1) support.

### (1) Support

Any material which is in the form of a stable panel and which satisfies required flexibility, strength, durability may be used as the support capable of being used in the present invention. In the event that the resulting electro-conductive polymer material is used in an image display device, a solar cell, or the like, a high transparency is required and therefore the use of a transparent substrate with a smooth surface is preferred.

In the present invention, examples of the material of the support include glass, transparent ceramics, metal and plastic film. Glass and transparent ceramics are inferior in plasticity to metal and plastic film. Plastic film is less expensive than metal and has plasticity. Therefore, plastic film is preferred as the support of the present invention. Examples thereof include films using resin such as cellulose diacetate, cellulose triacetate, cellulose propionate, cellulose butyrate, cellulose acetate butyrate, cellulose nitrate, polyethylene terephthalate, polyethylene, polystyrene, polypropylene, polycarbonate, polyvinyl acetal and polyarylate. In particular, polyester-based resins (hereinafter, suitably referred to as “polyesters”) are preferred. As the polyesters, preferred are linear saturated polyesters which are synthesized from an aromatic dibasic acid or its ester-forming derivative with a diol or its ester-forming derivative.

Specific examples of the polyester which may be used for the present invention include polyethylene terephthalate, polyethylene isophthalate, polyethylene naphthalate, polybutylene terephthalate, poly(1,4-cyclohexylenedimethylene terephthalate) and polyethylene 2,6-phthalene dicarboxylate. Among these, polyethylene terephthalate, polyethylene naphthalate are preferred from the viewpoint of easy availability, economical efficiency and effect.

Moreover, a mixture of these copolymers or a mixture of these polymers and other resins in a small proportion may also be used as the material of a film, unless the effect of the present invention is impaired.

Furthermore, for the purpose of improving a smoothness, it is permissible to cause the polyester film to contain a small amount of inorganic or organic particles, for example, inorganic fillers, such as titanium oxide, calcium carbonate, silica, barium sulfate and silicone, organic fillers, such as acryls, benzoguanamine, Teflon (registered trademark) and epoxy resin. Adhesive improvers or antistatic agents, such as polyethylene glycol (PEG) and sodium dodecylbenzene sulfonate may be included into the polyester film.

The polyester film to be used for the present invention may be produced by forming a polyester resin like that mentioned above into a film shape by melt extrusion; and then subjecting the resultant to oriented crystallization by longitudinal and transverse biaxial stretching and crystallization by heat treatment. As the method and condition regarding the production of such films, conventional methods and conditions may be selected appropriately and used.

The thickness of the support may be selected appropriately, and it generally is within a range of from 5 μm to 500 μm.

(2) Electro-Conductive Polymer Layer

### (Electro-Conductive Polymer)

The electro-conductive polymer to be used for the present invention refers to a polymer which exhibits an electrical conductivity of 10⁻⁶ S·cm⁻¹ or more. Any polymer corresponding to the above may be used. More preferred is a polymer having an electrical conductivity of 10⁻¹ S·cm⁻¹ or more.

The electro-conductive polymer is preferably a non-conjugated polymer or conjugated polymer made up of aromatic carbon rings or aromatic heterocycles linked by single bonds or divalent or multivalent linking groups.

The aromatic carbon rings in the non-conjugated polymer or conjugated polymer is, for example, a benzene ring and also may be formed a fused ring and also may have a substituent.

The aromatic heterocycle in the non-conjugated polymer or conjugated polymer is, for example, a pyridine ring, a pyrazine ring, a pyrimidine ring, a pyridazine ring, a triazine ring, an oxazole ring, a thiazole ring, an imidazole ring, an oxadiazole ring, a thiadiazole ring, a triazole ring, a tetrazole ring, a furan ring, a thiophene ring, a pyrrole ring, an indole ring, a carbazole ring, a benzimidazole ring, an imidazopyridine ring, or the like. It also may be formed a fused ring and may have a substituent.

Examples of the divalent or multivalent linking group in a non-conjugated polymer or conjugated polymer include linking groups formed by a carbon atom, a silicon atom, a nitrogen atom, a boron atom, an oxygen atom, a sulfur atom, metal, metal ion, or the like. Preferred are a carbon atom, a nitrogen atom, a silicon atom, a boron atom, an oxygen atom, a sulfur atom, and a group formed of a combination thereof. Examples of such a group formed of a combination include a methylene group, a carbonyl group, an imino group, a sulfonyl group, a sulfinyl group, an ester group, an amide group and a silyl group, which are either substituted or unsubstituted.

Specific examples of the electro-conductive polymer include polyaniline, poly(paraphenylene), poly(paraphenylenevinylene), polythiophene, polyfuran, polypyrrole, polyselenophene, polyisothianaphthene, polyphenylene sulfide, polyacethylene, polypyridylvinylene and polyazine, which are electro-conductive and are either substituted or non-substituted. These may be used either singly or, according to the purpose, in combination of two or more kinds thereof.

If a desired electrical conductivity is achieved, it may be used in the form of a mixture with another polymer having no electrical conductivity, and copolymers of such monomers with other monomers having no electrical conductivity may also be used.

The electro-conductive polymer is preferably a conjugated polymer. Examples of such a conjugated polymer include polyacethylene, polydiacetylene, poly(paraphenylene), polyfluorene, polyazulene, poly(paraphenylene sulfide)polypyrrole, polythiophene, polyisothianaphthene, polyaniline, poly(paraphenylenevinylene), poly(2,5-thienylenevinylene), multiple chain type conjugated polymers (polyperinaphthalene, an the like), metal phthalocyanine-type polymers, and other conjugated polymers [poly(paraxylylene), poly[α-(5,5′-bithiophenediyl)benzylidene], and the like).

Preferred are poly(paraphenylene), polypyrrole, polythiophene, polyaniline, poly(paraphenylenevinylene) and poly(2,5-thienylenevinylene). More preferred are poly(paraphenylene), polythiophene and poly(paraphenylenevinylene).

Such conjugated polymers may have a substituent, examples of the substituent include substituents which are described as R¹¹ in Formula (I) given below.

In the present invention, it is preferable, from the viewpoint of compatibility of high transparency and high electrical conductivity, particularly that the electro-conductive polymer have a partial structure represented by the following Formula (I) (in other words, that it be polythiophene or its derivative).

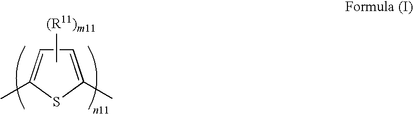

In Formula (I), R¹¹ represents a substituent; and m11 is an integer of from 0 to 2. When m11 represents 2, the R¹¹s may be either the same or different and also may be linked each other to form a ring. n¹¹ is an integer of 1 or greater.

The substituent represented by R¹¹ includes alkyl groups (preferably having 1 to 20 carbon atoms, more preferably having 1 to 12 carbon atoms, and still more preferably having 1 to 8 carbon atoms; for example, methyl, ethyl, isopropyl, tert-butyl, n-octyl, n-decyl, n-hexadecyl, cyclopropyl, cyclopentyl and, cyclohexyl), alkenyl groups (preferably having 2 to 20 carbon atoms, more preferably having 2 to 12 carbon atoms, and still more preferably having 2 to 8 carbon atoms; for example, vinyl, allyl, 2-butenyl, 3-pentenyl, 2-hexenyl, 3-hexenyl, 4-hexenyl and 2-octenyl), alkynyl groups (preferably having 2 to 20 carbon atoms, more preferably having 2 to 12 carbon atoms, and still more preferably having 2 to 8 carbon atoms; for example, propargyl and 3-pentynyl), aryl groups (preferably having 6 to 30 carbon atoms, more preferably having 6 to 20 carbon atoms, and still more preferably having 6 to 12 carbon atoms; for example, phenyl, p-methylphenyl and naphthyl), amino group (preferably having 0 to 20 carbon atoms, more preferably having 0 to 10 carbon atoms, and still more preferably having 0 to 6 carbon atoms; for example, amino, methylamino, dimethylamino, diethylamino, dibenzylamino, and diphenylamino),

alkoxy groups (preferably having 1 to 20 carbon atoms, more preferably having 1 to 12 carbon atoms, and still more preferably having 1 to 8 carbon atoms; for example, methoxy, ethoxy, butoxy, hexyloxy and octyloxy), aryloxy groups (preferably having 6 to 20 carbon atoms, more preferably having 6 to 16 carbon atoms, and still more preferably having 6 to 12 carbon atoms; for example, phenyloxy and 2-naphthyloxy), acyl groups (preferably having 1 to 20 carbon atoms, more preferably having 1 to 16 carbon atoms, and still more preferably having 1 to 12 carbon atoms; for example, acetyl, benzoyl, formyl and pivaloyl), alkoxycarbonyl groups (preferably having 2 to 20 carbon atoms, more preferably having 2 to 16 carbon atoms, and still more preferably having 2 to 12 carbon atoms; for example, methoxycarbonyl and ethoxycarbonyl), aryloxycarbonyl groups (preferably having 7 to 20 carbon atoms, more preferably having 7 to 16 carbon atoms, and still more preferably having 7 to 10 carbon atoms; for example, phenyloxycarbonyl),

acyloxy group (preferably having 2 to 20 carbon atoms, more preferably having 2 to 16 carbon atoms, and still more preferably having 2 to 10 carbon atoms; for example, acetoxy and benzoyloxy), acylamino groups (preferably having 2 to 20 carbon atoms, more preferably having 2 to 16 carbon atoms, and still more preferably having 2 to 10 carbon atoms; for example, acetylamino and benzoylamino), alkoxycarbonylamino groups (preferably having 2 to 20 carbon atoms, more preferably having 2 to 16 carbon atoms, and still more preferably having 2 to 12 carbon atoms; for example, methoxycarbonylamino), aryloxycarbonylamino groups (preferably having 7 to 20 carbon atoms, more preferably having 7 to 16 carbon atoms, and still more preferably having 7 to 12 carbon atoms; for example, phenyloxycarbonylamino), sulfonylamino groups (preferably having 1 to 20 carbon atoms, more preferably having 1 to 16 carbon atoms, and still more preferably having 1 to 12 carbon atoms; for example, methanesulfonylamino and benzenesulfonylamino), a sulfamoyl group (preferably having 0 to 20 carbon atoms, more preferably having 0 to 16 carbon atoms, and still more preferably having 0 to 12 carbon atoms; for example, sulfamoyl, methylsulfamoyl, dimethylsulfamoyl and phenylsulfamoyl),

carbamoyl groups (preferably having 1 to 20 carbon atoms, more preferably having 1 to 16 carbon atoms, and still more preferably having 1 to 12 carbon atoms; for example, carbamoyl, methylcarbamoyl, diethylcarbamoyl and phenylcarbamoyl), alkylthio groups (preferably having 1 to 20 carbon atoms, more preferably having 1 to 16 carbon atoms, and still more preferably having 1 to 12 carbon atoms; for example, methylthio and ethylthio), arylthio groups (preferably having 6 to 20 carbon atoms, more preferably having 6 to 16 carbon atoms, and still more preferably having 6 to 12 carbon atoms; for example, phenylthio), sulfonyl groups (preferably having 1 to 20 carbon atoms, more preferably having 1 to 16 carbon atoms, and still more preferably having 1 to 12 carbon atoms; for example, mesyl and tosyl), sulfinyl groups (preferably having 1 to 20 carbon atoms, more preferably having 1 to 16 carbon atoms, and still more preferably having 1 to 12 carbon atoms; for example, methanesulfinyl and benzenesulfinyl), ureido groups (preferably having 1 to 20 carbon atoms, more preferably having 1 to 16 carbon atoms, and still more preferably having 1 to 12 carbon atoms; for example, ureido, methylureido and phenylureido), phosphoramide groups (preferably having 1 to 20 carbon atoms, more preferably having 1 to 16 carbon atoms, and still more preferably having 1 to 12 carbon atoms; for example, diethyl phosphoramide and phenyl phosphoramide),

a hydroxy group, a mercapto group, halogen atoms (for example, fluorine atom, chlorine atom, bromine atom and iodine atom), a cyano group, a sulfo group, a carboxyl group, a nitro group, a hydroxamic acid group, a sulfino group, a hydrazino group, an imino group, heterocyclic groups (preferably having 1 to 20 carbon atoms and more preferably having 1 to 12 carbon atoms; examples of hetero atoms include a nitrogen atom, an oxygen atom and a sulfur atom; specific examples include pyrrolidine, piperidine, piperazine, morpholine, thiophene, furan, pyrrole, imidazole, pyrazole, pyridine, pyrazine, pyridazine, triazole, triazine, indole, indazole, purine, thiazoline, thiazole, thiadiazole, oxazoline, oxazole, oxadiazole, quinoline, isoquinoline, phthalazine, naphthylydine, quinoxaline, quinazoline, cinnoline, pteridine, acridine, phenanthroline, phenazine, tetrazole, benzimidazole, benzoxazole, benzthiazole, benzotriazole and tetraazaindene), and silyl groups (preferably having 3 to 40 carbon atoms, more preferably having 3 to 30 carbon atoms, and still more preferably having 3 to 24 carbon atoms; for example, trimethylsilyl and triphenylsilyl).

The substituent represented by R¹¹ may be additionally substituted. When it has a plural substituents, they may be either the same or different and may, if possible, be linked together to form a ring. Examples of the ring to be formed include a cycloalkyl ring, a benzene ring, a thiophene ring, a dioxane ring and a dithiane ring.

The substituent represented by R¹¹ is preferably an alkyl group, an alkenyl group, an alkynyl group, an alkoxy group and an alkylthio group, and more preferably an alkyl group, an alkoxy group and an alkylthio group. In still more preferably, when m11 is 2, two R¹¹s are alkoxy groups or alkylthio groups forming a ring, and it is preferable to form a dioxane ring or a dithiane ring.

When m11 is 1 in Formula (I), R¹¹ is preferably an alkyl group, and more preferably an alkyl group having 2 to 8 carbon atoms.

When Formula (I) is poly(3-alkylthiophene) that R¹¹ is an alkyl group, the linkage mode between the adjacent thiophene rings includes a sterically regular mode in which all thiophene rings are linked by 2-5′ and a sterically irregular mode which contains 2-2′ linkages and 5-5′ linkages. Among them, the sterically irregular mode is preferred.

In the present invention, it is particularly preferable, from the viewpoint of achieving both high transparency and high electrical conductivity, that the electro-conductive polymer is 3,4-ethylenedioxy-polythiophene, which is specific example compound (6) shown below.

The polythiophene represented by Formula (I) and derivatives thereof may be prepared by known methods such as those disclosed in J. Mater. Chem., 15, 2077-2088 (2005) and Advanced Materials, 12(7), 481 (2000). For examples, Denatron P502 (manufactured by NAGASE CHEMICAL CO., LTD.), 3,4-ethylenedioxythiophene (BAYTRON (registered trademark) M V2), and 3,4-polyethylenedioxythiopene/polystyrenesulfonate (BAYTRON (registered trademark) P), BAYTRON (registered trademark) C), BAYTRON (registered trademark) F E, BAYTRON (registered trademark) M V2, BAYTRON (registered trademark) P, BAYTRON (registered trademark) P AG, BAYTRON (registered trademark) P HC V4, BAYTRON (registered trademark) P HS, BAYTRON (registered trademark) PH, BAYTRON (registered trademark) PH 500 and BAYTRON (registered trademark) PH 510 (all the BAYTRONs are manufactured by H.C. Starck GmbH) may be-obtained as commercial products. A polyaniline (manufactured by Aldrich Chemical Company, Inc.), a polyaniline (ereraldine (phonetic) base) (manufactured by Aldrich Chemical Company, Inc.), or the like are available as polyaniline and derivatives thereof.

A polypyrrole (manufactured by Aldrich Chemical Company, Inc.) or the like are available as polypyrrole and derivatives thereof.

Specific examples of an electro-conductive polymer are shown below, but the present invention is not limited to them. Besides these, compounds disclosed in W098/01909 and so on are also provided as examples.

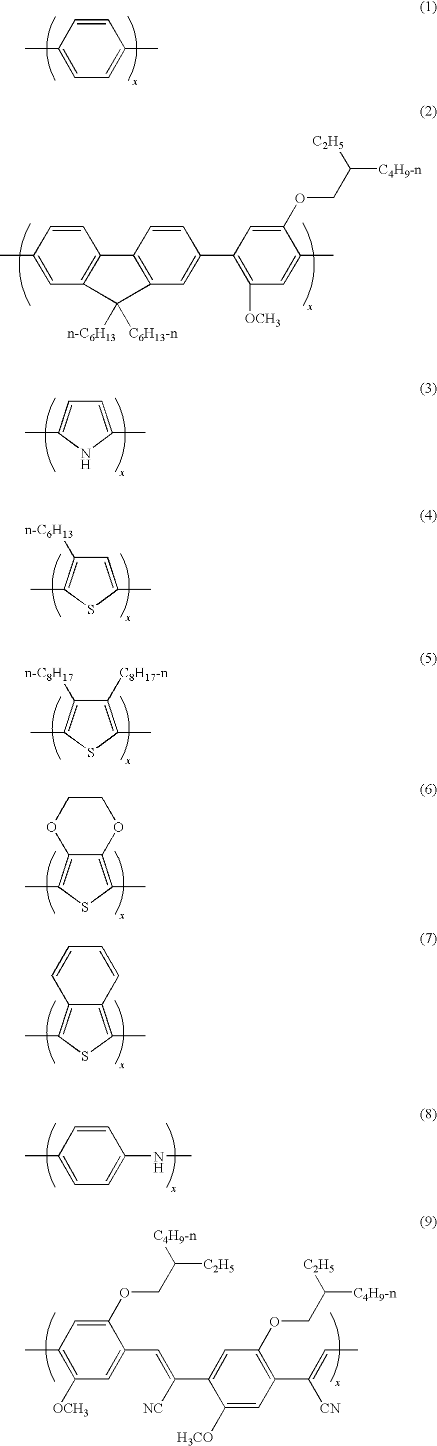

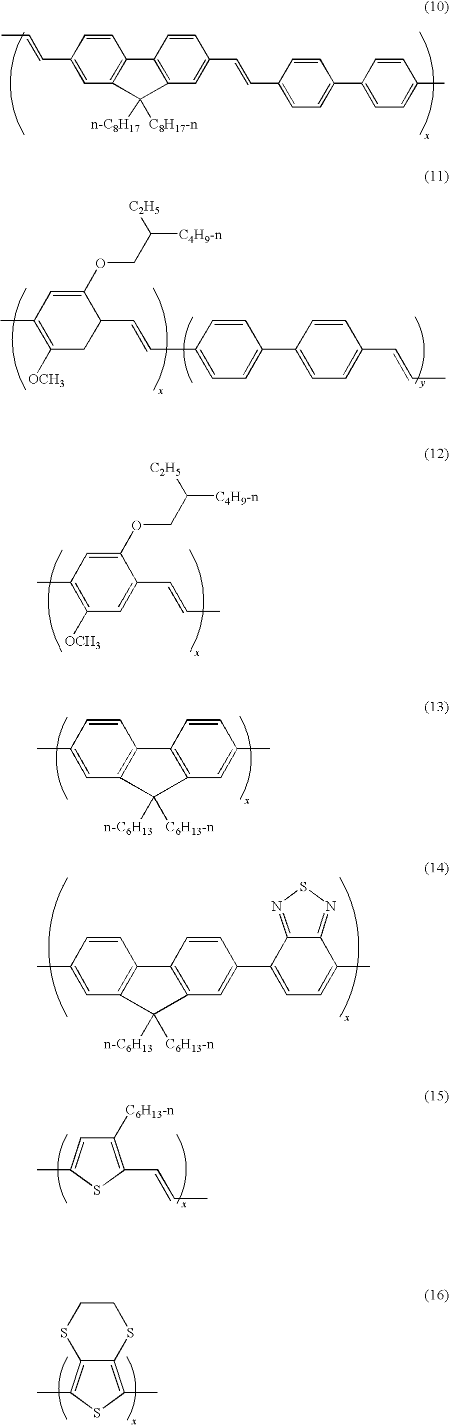

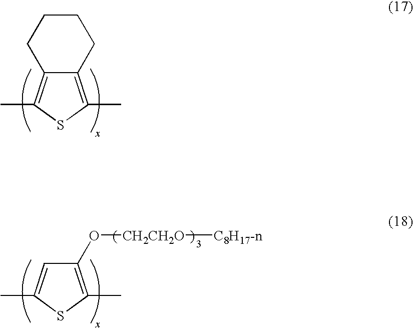

The weight average molecular weight of an electro-conductive polymer to be used in the present invention is preferably from 1,000 to 1,000,000, more preferably from 10,000 to 500,000, and still more preferably from 10,000 to 100,000.

(Dopant)

From the viewpoint that the dispersibility of the electro-conductive polymer in a solvent is improved, it is preferable that the electro-conductive polymer layer contain at least one dopant in addition to the above the electro-conductive polymer. The electro-conductive polymer layer is suitably formed by coating as described below. To obtain a dispersion liquid (composition) with favorable dispersibility is important from the viewpoint of production. The dopant as used herein means an additive which has an action of changing the electrical conductivity of an electro-conductive polymer. Such dopants include electron-accepting (i.e., acceptor) dopants and electron-donating (i.e., donor) dopants.

Examples of electron-accepting (i.e., acceptor) dopants include halogens (Cl₂, Br₂, I₂, ICl, ICl₃, IBr, IF), Lewis acids (PF₅, AsF₅, SbF₅, BF₃, BCl₃, BBr₃, SO₃), proton acids (HF, HCl, HNO₃, H₂SO₄, HClO₄, FSO₃H, CISO₃H, CF₃SO₃H, various organic acids, amino acids, and the like), transition metal compounds (FeCl₃, FeOCl, TiCl₄, ZrCl₄, HfCl₄, NbF₅, NbCl₅, TaCl₅, MoF₅, MoCl₅, WF₆, WCl₆, UF₆, LnCl₃ (Ln is lanthanide, such as La, Ce, Pr, Nd, and Sm), electrolyte anions (Cl⁻, Br⁻, I⁻, ClO₄⁻, PF₆⁻, AsF₆⁻, SbF₆⁻, BF₄⁻, various sulfonate anions), O₂, XeOF₄ (NO₂⁺)(SbF₆⁻), (NO₂⁺)(SbCl₆⁻), (NO₂⁺)(BF₄⁻), FSO₂OOSO₂F, AgClO₄, H₂IrCl₆ La(NO₃)₃.6H₂O.

Examples of electron-donating (i.e., donor) dopants include alkali metals (Li, Na, K, Rb, Cs), alkaline earth metals (Ca, Sr, Ba), lanthanides (Eu, or the like), and others (R₄N⁺, R₄P⁺, R₄As⁺, R₃S⁺, acetylcholine).

Examples of the combination of the dopant and the electro-conductive polymer include:
(A) polyacethylene with I₂, AsF₅, FeCl₃ or the like;
(B) poly(p-phenylene) with AsF₅, K, AsF₆⁻ or the like;
(C) polypyrrole with ClO₄⁻ or the like;
(D) polythiophene with ClO₄⁻, or a sulfonic acid compound, especially polystyrene sulfonic acid, a nitrosonium salt, an aminium salt, a quinone, or the like;
(E) polyisothianaphthene with I₂ or the like;
(F) poly(p-phenylene sulfide) with AsF₅;
(G) poly(p-phenyleneoxide) with AsF₅;
(H) polyaniline with HCl or the like;
(I) poly(p-phenylenevinylene) with H₂SO₄ or the like;
(J) polythiophenylenevinylene with I₂ or the like;
(K) nickel phthalocyanine with I₂.

Among these combinations, preferred is the combination (D), more preferred, from the viewpoint that the dope condition is high in stability, is the combination of polythiophenes (polythiophene and its derivative) with a sulfone compound, and still more preferred, from the viewpoint that the aqueous dispersion liquid may be prepared and an electro-conductive thin film may be prepared easily by coating, is the combination of a polythiophene with a polystyrene sulfonic acid.

The ratio of the electro-conductive polymer to the dopant may be any value. From the viewpoint of well achieving both the stability of the dope condition and the electrical conductivity, the weight ratio of the electro-conductive polymer to the dopant (electro-conductive polymer: the dopant) is preferably within a range of from 1.0:0.0000001 to 1.0:10, more preferably within a range of from 1.0:0.00001 to 1.0: 1.0, and still more preferably within a range of 1.0:0.0001 to 1.0:0.5.

In order to improve the dispersibility of an electro-conductive polymer, an ion-conductive polymer in which polymer chain has been doped with an electrolyte may be used. Examples of such a polymer chain include polyethers (polyethylene oxide, polypropylene oxide, and the like), polyesters (polyethylene succinate, poly-β-propiolactone, and the like), polyamines (polyethyleneimine, and the like), and polysulfides (polyalkylene sulfide, and the like). The electrolyte doped may be various alkali metal salts.

Examples of the alkali metal ion which constitutes the alkali metal salt include Li⁺, Na⁺, K⁺, Rb⁺ and Cs⁺. Examples of the anion which forms the counter salt include F⁻, C⁻, Br⁻, I⁻, NO₃⁻, SCN⁻, ClO₄⁻, CF₃SO₃⁻, BF₄⁻, AsF₆⁻ and BPh₄⁻.

Examples of the combination of the polymer chain and the alkali metal salt include polyethylene oxide with LiCF₃SO₃, LiClO₄ or the like, polyethylene succinate with LiClO₄, LiBF₄, poly-β-propiolactone, LiClO₄ or the like, polyethyleneimine with NaCF₃SO₃, LiBF₄ or the like, and polyalkylene sulfide with AgNO₃ or the like.

It is also possible to additionally add a solvent, described below, and other additives to the electro-conductive polymer layer of the present invention. The available additives include UV absorbers, inorganic fine particles and polymer particles for the purpose of increasing the film strength, silane coupling agents, and fluorine-containing compounds (especially, fluorine-containing surfactants) for the purpose of reducing a refractive index and increasing transparency simultaneously.

The thickness of the electro-conductive polymer layer is not particularly limited, and it is preferably within a range of from 1 nm to 2 μm, and more preferably within a range of from 10 nm to 1 μm. When the thickness of the electro-conductive polymer layer is within such a range, a sufficient electrical conductivity and a sufficient transparency may be attained.

(3) Doped State Stabilization Layer

The present invention includes a doped state stabilization layer (layer containing at least one selected from an acidic compound or a reducing agent) in addition to the electro-conductive polymer layer.

The “acidic compound” in the present invention means a compound that has a dissociative hydrogen atom and a dissociation constant pH of 6 or less.

The “reducing agent” in the present invention means an electron donor compound.

There exist present compounds having both of the functions of an acidic compound and a reducing agent, and such compounds may also be used in the present invention. Accordingly, as long as the definitions of the acidic compound and/or the reducing agent mentioned above are satisfied, there is no need for clearly differentiating whether the compound is an acidic compound or a reducing agent.

Herein, acting functions of the acidic compound and reducing agent are inferred to be as follows. However, the present invention is not restricted by the inference.

It is inferred that the “acidic compound” stabilizes a doped state of the electro-conductive polymer, and that, when the electro-conductive polymer is oxidized over time, the “reducing agent” recovers the polymer to the doped state from an oxidized state owing to a reducing action of the reducing agent, and thereby the electro-conductive polymer is inhibited from deteriorating in performance. Thus, both the acidic compound and reducing agent are inferred to function so as to constantly maintain the doped state of the electro-conductive polymer.

An acting function of maintaining a doped state of the electro-conductive polymer when the acidic compound or reducing agent is added to a different layer from the electro-conductive polymer is not clarified, but is inferred to be as follows. However, the present invention is not restricted by this inference.

It is inferred that the acidic compound and/or reducing agent moves between layers to reach an electro-conductive polymer-containing layer to maintain the doped state, or that the acidic compound and/or reducing agent traps oxygen to inhibit the electro-conductive polymer from oxidizing, and thereby the doped state of the electro-conductive polymer is maintained.

In the case where the acidic compound and/or reducing agent and the electro-conductive polymer are added in separate layers, a distance between the acidic compound and/or reducing agent and the electro-conductive polymer is farther in comparison with the case where these are added in the same layer, and there is an interface between the respective layers. It is not expected that the photo-durability is improved irrespective of such a state.

The acidic compound and reducing agent of the present invention are not particularly restricted as long as the compound corresponds to the definitions.

Examples of the acidic compound used in the present invention include polyphosphoric acid, a hydroxy compound, a carboxy compound and a sulfonic acid compound. Among these, polyphosphoric acid or a sulfonic acid compound, which has high acid level, is preferred from the viewpoint of the stability of a doped state of the electro-conductive polymer, and polyphosphoric acid is particularly preferred. Among the compounds, there are compounds that function as a reducing agent depending on the kind of a substituent.

Examples of the reducing agent used in the present invention include a thioether compound, a succinimide compound, a polyol compound, a hydroxamic acid compound, other amide compounds, a nitrogen-containing heteroring compound and a hydroxyamine compound. Among these, a thioether compound, a succinimide compound, a polyol compound, a hydroxamic acid compound and a hydroxyamine compound are preferred from the viewpoint of having appropriate reducing power, and a succinimide compound, a polyol compound and a hydroxamic acid compound are more preferred. Among the compounds, there are compounds that function as the acidic compound depending on the kind of the substituent.

The acidic compound and reducing agent of the present invention, as long as the definitions are satisfied, may be compounds corresponding to at least two of a polyphosphoric acid compound, a hydroxy compound, a carboxy compound, a sulfonic acid compound, a thioether compound, a succinimide compound, a polyol compound, a hydroxamic acid compound, other amide compounds, a nitrogen-containing heteroring compound and a hydroxyamine compound.

In what follows, compounds usable as the acidic compound or reducing agent in the present invention will be more detailed.

—Polyphosphoric Acid—

The polyphosphoric acid of the present invention includes diphosphoric acid, pyrophosphoric acid, triphosphoric acid, tetraphosphoric acid, metaphosphoric acid, polyphosphoric acid and salts thereof. Mixture thereof may also be used.

The polyphosphoric acid in the present invention is preferred to be diphosphoric acid, pyrophosphoric acid, triphosphoric acid or polyphosphoric acid, polyphosphoric acid being more preferred.

The polyphosphoric acid is synthesized by heating H₃PO₄ together with sufficient P₄O₁₀ (phosphoric anhydride), or by heating H₃PO₄ to remove water.

—Hydroxy Compound—

A hydroxy compound is a compound having at least one hydroxyl group and preferably having a phenolic hydroxyl group.

As the hydroxy compounds, compounds represented by the following Formula (II) are preferred.

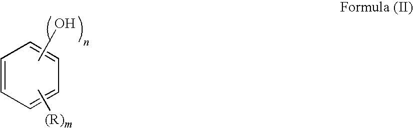

In Formula (II), R represents a sulfo group, a halogen atom, an alkyl group, an aryl group, a carboxy group or an alkoxycarbonyl group; n is from 1 to 6; and m represents from 0 to 5.

As the R, a sulfo group, an alkyl group, an aryl group, a carboxy group or an alkoxycarbonyl group is preferred, and a sulfo group being more preferred.

n is preferably from 1 to 5, more preferably from 1 to 4, and still more preferably from 1 to 3.

m is preferably from 0 to 5, more preferably from 0 to 4, and still more preferably from 0 to 3.

—Polyol Compound—

A polyol compound is a compound having at least two alcoholic hydroxyl groups.

As the polyol compound, compounds represented by the following Formula (VIII) are preferred.

HO-A-OH Formula (VIII)

In Formula (VIII), A represents a divalent linking group. As this divalent linking group, combinations of an alkylene group, an arylene group or an alkenylene group and an oxygen atom, a sulfur atom or a nitrogen atom are preferred, and combinations of an alkylene group or an arylene group and an oxygen atom or a sulfur atom being more preferred.

In the case where the divalent linking group is a combination of an alkylene group and a sulfur atom, the compound corresponds to a thioether compound described below. This thioether compound is preferably used.

When a divalent linking group represented by A contains an alkylene group, the alkylene group may have a substituent. The substituent is preferred to be a hydroxy group or an aryl group, and the hydroxy group being more preferably possessed as a substituent.

—Carboxy Compound—

A carboxy compound is a compound having at least one carboxy group.

As the carboxy compound, compounds represented by the following Formula (III) or (IV) are preferred.

HOOC-A-COOH Formula (III)

In Formula (III), A represents a single bond or a divalent linking group. As this divalent linking group, combinations of an alkylene group, an arylene group or an alkenylene group and an oxygen atom, a sulfur atom or a nitrogen atom are preferred, and combinations of an alkylene group or an arylene group and an oxygen atom or a sulfur atom being more preferred.

In the case where the divalent linking group is a combination of an alkylene group and a sulfur atom, the compound corresponds to a thioether compound described below. This thioether compound is preferably also used.

When a divalent linking group represented by A contains an alkylene group, the alkylene group may have a substituent. The substituent is preferred to be an alkyl group, and a carboxy group being more preferably possessed as a substituent.

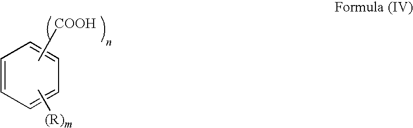

In Formula (IV), R represents a sulfo group, a halogen atom, an alkyl group, an aryl group, a hydroxy group or an alkoxycarbonyl group; n is from 1 to 6 and; m is from 0 to 5.

As the R, a sulfo group, an alkyl group, an aryl group, a hydroxy group or an alkoxycarbonyl group is preferred, and a sulfo group or an alkoxycarbonyl group being more preferred.

n is preferably from 1 to 5, more preferably from 1 to 4, and still more preferably from 1 to 3.

m is preferably from 0 to 5, more preferably from 0 to 4, and still more preferably from 0 to 3.

—Sulfonic Acid Compound—

A sulfonic acid compound is a compound having at least one sulfo group, and preferably having at least two sulfo groups.

A sulfonic acid compound is preferably substituted with an aryl group or an alkyl group, and more preferably with an aryl group.

In the hydroxy compound and carboxy compound described above, compounds having a sulfo group as a substituent are also preferred.

—Thioether Compound—

A thioether compound is not particularly restricted as long as it has a thioether structure in a molecule. A polythioether where at least two thioether structures repeat in a molecule is more preferred. The thioether compound has, for instance, a thioether structure shown below.

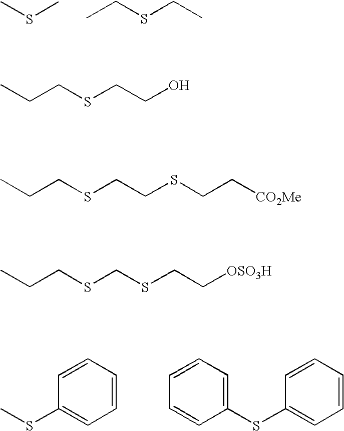

A compound having a thioether structure may further have a substituent. Examples of the substituent include an alkyl group, an aryl group and a nitrogen-containing heteroring, a case where an alkyl group or an aryl group is possessed being specially preferred.

—Succinimide Compound—

As a succinimide compound, compounds represented by the following Formula (V) are preferred.

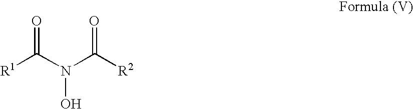

R¹ and R² each in Formula (V) independently represent a hydrogen atom, an alkyl group, an aryl group, a heteroaryl group, a polyvinyl group, a polypropylene group or a polystyrene group, a hydrogen atom, alkyl groups having 1 to 30 carbon atoms or a phenyl group being preferred, and a hydrogen atom, alkyl groups having 1 to 15 carbon atoms or a phenyl group being more preferred. Furthermore, R¹ and R² may combine each other to form a ring.

The alkyl groups represented by R¹ and R² may be further substituted. Preferable examples of the substituent include a sulfo group or a salt thereof, a phosphone group, a carboxy group and a hydroxy group, and a sulfo group or a salt thereof and carboxy group or a base thereof being more preferred.

The R¹ and R² may be same with or different from each other. A case where R¹ and R² are same with each other is possessed being preferred, from the viewpoint of easy availability.

—Hydroxamic Acid Compound and Hydroxyamine Compound—

A Hydroxamic acid compound and a hydroxyamine compound are preferably compounds represented by the following Formula (1).

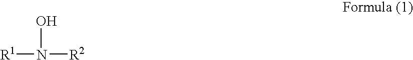

In Formula (1), R¹ represents a hydrogen atom, an alkyl group, an acyl group, an aryl group, an alkoxy group, an aryloxy group or a heteroaryl group. In Formula (1), R² represents a hydrogen atom, an alkyl group, an aryl group, a heteroaryl group or a sulfonyl group.

R¹ and R² in Formula (1) each may have a substituent. The substituents may be in the following substituent group V.

(Substituent Group V)

Halogen atom (for example, chlorine, bromine, iodine, fluorine); a mercapto group; a cyano group; a carboxyl group; a phosphoric acid group; a sulfo group; a hydroxy group; carbamoyl groups having 1 to 10 carbon atoms, preferably having 2 to 8 carbon atoms, and more preferably having 2 to 5 carbon atoms (for example, a methylcarbamoyl group, an ethylcarbamoyl group and a morpholinocarbamoyl group); sulfamoyl groups having 0 to 10 carbon atoms, preferably having 2 to 8 carbon atoms, and more preferably having 2 to 5 carbon atoms (for example, a methylsulfamoyl group, an ethylsulfamoyl group and a piperidinosulfamoyl group); a nitro group; alkoxy groups having 1 to 20 carbon atoms, preferably having 1 to 10 carbon atoms, and more preferably having 1 to 8 carbon atoms (for example, a methoxy group, an ethoxy group, a 2-methoxyethoxy group and a 2-phenylethoxy group); aryloxy groups having 6 to 20 carbon atoms, preferably having 6 to 12 carbon atoms, and more preferably having 6 to 10 carbon atoms (for example, a phenoxy group, a p-methylphenoxy group, a p-chlorophenoxy group and a naphthoxy group); acyl groups having 1 to 20 carbon atoms, preferably having 2 to 12 carbon atoms, and more preferably having 2 to 8 carbon atoms (for example, an acetyl group, a benzoyl and a trichloroacetyl group); acyloxy groups having 1 to 20 carbon atoms, preferably having 2 to 12 carbon atoms, and more preferably having 2 to 8 carbon atoms (for example, an acetyloxy group and a benzoyloxy group); acylamino groups having 1 to 20 carbon atoms, preferably having 2 to 12 carbon atoms, and more preferably having 2 to 8 carbon atoms (for example, an acetylamino group);

sulfonyl groups having 1 to 20 carbon atoms, preferably having 1 to 10 carbon atoms, and more preferably having 1 to 8 carbon atoms (for example, a methanesulfonyl group, an ethanesulfonyl group and a benzenesulfonyl group); sulfinyl groups having 1 to 20 carbon atoms, preferably having 1 to 10 carbon atoms, and more preferably having 1 to 8 carbon atoms (for example, a methanesulfinyl group, an ethanesulfinyl group and a benzenesulfinyl group); sulfonylamino groups having 1 to 20 carbon atoms, preferably having 1 to 10 carbon atoms, and more preferably having 1 to 8 carbon atoms (for example, a methanesulfonylamino group, an ethanesulfonylamino group and a benzenesulfonylamino group); substituted or unsubstituted amino groups having 0 to 20 carbon atoms, preferably having 0 to 12 carbon atoms, and more preferably having 0 to 8 carbon atoms (for example, an unsubstituted amino group, a methylamino group, a dimethylamino, a benzylamino group, an anilino group and a diphenylamino group); ammonium groups having 0 to 15 carbon atoms, preferably having 3 to 10 carbon atoms, and more preferably having 3 to 6 carbon atoms (for example, a trimethylammonium group and a triethylammonium group); hydrazino groups having 0 to 15 carbon atoms, preferably having 1 to 10 carbon atoms, and more preferably having 1 to 6 carbon atoms (for example, a trimethylhydrazino group); ureido groups having 1 to 15 carbon atoms, preferably having 1 to 10 carbon atoms, and more preferably having 1 to 6 carbon atoms (for example, an ureido group and an N,N-dimethylureido group); imide groups having 1 to 15 carbon atoms, preferably having 1 to 10 carbon atoms, and more preferably having 1 to 6 carbon atoms (for example, a succinimide group);

alkylthio groups having 1 to 20 carbon atoms, preferably having 1 to 12 carbon atoms, and more preferably having 1 to 8 carbon atoms (for example, a methylthio group, an ethylthio group and a propylthio group); arylthio groups having 6 to 80 carbon atoms, preferably having 6 to 40 carbon atoms, and more preferably having 6 to 30 carbon atoms (for example, a phenylthio group, a p-methylphenylthio group, a p-chlorophenylthio group, a 2-pyridylthio group, a 1-naphthylthio group, a 2-naphthylthio group, a 4-propylcyclohexyl-4′-biphenylthio group, a 4-butylcyclohexyl-4′-biphenylthio group, a 4-pentylcyclohexyl-4′-biphenylthio group and a 4-propylphenyl-2-ethynyl-4′-biphenylthio group); heteroarylthio groups having 1 to 80 carbon atoms, preferably having 1 to 40 carbon atoms, and more preferably having 1 to 30 carbon atoms (for example, a 2-pyridylthio group, a 3-pyridylthio group, a 4-pyridylthio group, a 2-quinolylthio group, 2-furilthio group and a 2-pyrrolylthio group); alkoxycarbonyl groups having 2 to 20 carbon atoms, preferably having 2 to 12 carbon atoms, and more preferably having 2 to 8 carbon atoms (for example, a methoxycarbonyl group, an ethoxycarbonyl group and a 2-benzyloxycarbonyl group), aryloxycarbonyl groups having 6 to 20 carbon atoms, preferably having 6 to 12 carbon atoms, and more preferably having 6 to 10 carbon atoms (for example, a phenoxycarbonyl group);

unsubstituted alkyl groups having 1 to 18 carbon atoms, preferably having 1 to 10 carbon atoms, and more preferably having 1 to 5 carbon atoms (for example, a methyl group, an ethyl group, a propyl group and a butyl group); substituted alkyl groups having 1 to 18 carbon atoms, preferably having 1 to 10 carbon atoms, and more preferably having 1 to 5 carbon atoms (for example, a hydroxymethyl, a trifluoromethyl group, a benzyl group, a carboxyethyl group, an ethoxycarbonylmethyl group and an acetylaminomethyl group, wherein unsaturated hydrocarbon groups having 2 to 18 carbon atoms, preferably having 3 to 10 carbon atoms, and more preferably having 3 to 5 carbon atoms (for example, a vinyl group, an ethynyl group, a 1-cyclohexenyl group, a benzylidyne group and a benzylidene group) shall be included in the substituted alkyl groups); substituted or unsubstituted aryl groups having 6 to 20 carbon atoms, preferably having 6 to 15 carbon atoms, and more preferably having 6 to 10 carbon atoms (for example, a phenyl group, a naphthyl group, a p-carboxyphenyl group, a p-nitrophenyl group, a 3,5-dichlorophenyl group, a p-cyanophenyl group, a m-fluorophenyl group, a p-tolyl group, 4-propylcyclohexyl-4′-biphenyl, 4-butylcyclohexyl-4′-biphenyl, 4-pentylcyclohexyl-4′-biphenyl and 4-propylphenyl-2-ethynyl-4′-biphenyl); and substituted or unsubstituted heterocyclic groups having 1 to 20 carbon atoms, preferably having 2 to 10 carbon atoms, and more preferably having 4 to 6 carbon atoms (for example, a pyridyl group, a 5-methylpyridyl group, a thienyl group, a furil group, a morpholino group and a tetrahydrofurfuryl group) are included.

Substituents of the substituent group V may form a structure in which a benzene ring or a naphthalene ring is fused. Furthermore, such substituents may be additionally substituted.

Such an additional substituent may be any one selected from the substituent group V.

The alkyl group represented by R¹ of Formula (1) is an alkyl group preferably having 1 to 60 carbon atoms, more preferably having 1 to 50 carbon atoms, and still more preferably having 1 to 40 carbon atoms. Specific examples are methyl, tert-butyl, tert-octyl, 2-ethylhexyl, cyclohexyl, n-hexadecyl, 3-dodecyloxypropyl and 3-(2′,4′-di-tert-pentylphenoxy)propyl.

The acyl group represented by R¹ of Formula (1) is an acyl group preferably having 1 to 60 carbon atoms, more preferably having 1 to 50 carbon atoms, and still more preferably having 1 to 40 carbon atoms. Specific examples include acetyl, benzoyl, trichloroacetyl, a phenylcarbonyl group and an ethylcarbonyl group.

The aryl group represented by R¹ of Formula (1) is an aryl group preferably having 6 to 60 carbon atoms, more preferably having 6 to 50 carbon atoms, and still more preferably having 6 to 40-carbon atoms. Specific examples include phenyl, 1-naphthyl, p-tolyl, o-tolyl, 4-methoxyphenyl, 4-hexadecyloxyphenyl, 3-pentadecylphenyl, 2,4-di-tert-pentylphenyl, 8-quinolyl and 5-(1-dodecyloxycarbonylethoxycarbonyl)-2-chlorophenyl.

The alkoxy group represented by R¹ of Formula (1) is an alkoxy group preferably having 1 to 60 carbon atoms, more preferably having 1 to 50 carbon atoms, and still more preferably having 1 to 40 carbon atoms. Specific examples include methoxy, ethoxy, butoxy, methoxyethoxy and n-octyloxy.

The aryloxy group represented by R¹ of Formula (1) is an aryloxy group preferably having 6 to 60 carbon atoms, more preferably having 6 to 50 carbon atoms, and still more preferably having 6 to 40 carbon atoms. Specific examples include phenoxy and 4-tert-octylphenoxy.

The heteroaryl group represented by R¹ of a Formula (1) is preferably a 5- to 8-membered heteroaryl group containing at least one heteroatom selected from among N, S, O and Se. Specific examples include 4-pyridyl, 2-furil, 2-pyrrole, 2-thiazolyl, 3-thiazolyl, 2-oxazolyl, 2-imidazolyl, triazolyl, tetrazolyl, benzotriazolyl, 2-quinolyl and 3-quinolyl.

The alkyl group represented by R² of Formula (1) is an alkyl group preferably having 1 to 60 carbon atoms, more preferably having 1 to 50 carbon atoms, and still more preferably having 1 to 40 carbon atoms. Specific examples include methyl, tert-butyl, tert-octyl, 2-ethylhexyl, cyclohexyl, n-hexadecyl, 3-dodecyloxypropyl and 3-(2′,4′-di-tert-pentylphenoxy)propyl.

The aryl group represented by R² of Formula (1) is an aryl group preferably having 6 to 60 carbon atoms, more preferably having 6 to 50 carbon atoms, and still more preferably having 6 to 40 carbon atoms. Specific examples include phenyl, 1-naphthyl, p-tolyl, o-tolyl, 4-methoxyphenyl, 4-hexadecyloxyphenyl, 3-pentadecylphenyl, 2,4-di-tert-pentylphenyl, 8-quinolyl and 5-(1-dodecyloxycarbonylethoxycarbonyl)-2-chlorophenyl.

The heteroaryl group represented by R² of a Formula (1) is preferably a 5- to 8-membered heteroaryl group containing at least one heteroatom selected from among N, S, O and Se. Specific examples include 4-pyridyl, 2-furil, 2-pyrrole, 2-thiazolyl, 3-thiazolyl, 2-oxazolyl, 2-imidazolyl, triazolyl, tetrazolyl, benzotriazolyl, morpholinyl, and the like.

The sulfonyl group represented by R² of Formula (1) is a sulfonyl group preferably having 1 to 60 carbon atoms, more preferably having 1 to 50 carbon atoms, and still more preferably having 1 to 40 carbon atoms. Specific examples include phenylslufonyl, methylsulfonyl, ethylsulfonyl and propylsulfonyl.

R¹ and R² may be either the same or different. Moreover, R¹ and R² may be linked together to form a ring.

As the Hydroxamic acid compound and hydroxyamine compound represented by Formula (1) used in the present invention, hydroxamic acid compounds represented by the following Formula (2) and hydroxyamine compounds represented by the following Formula (3) are preferred.

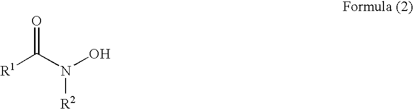

In Formula (2), R¹ is a hydrogen atom, an alkyl group, an aryl group, a heteroaryl group, an alkoxy group or an aryloxy group, is preferably an alkyl group or an aryl group, and more preferably an alkyl group or a phenyl group which may be substituted.

The alkyl group represented by R¹ of Formula (2) is preferably an alkyl group having 1 to 60 carbon atoms, more preferably an alkyl group having 1 to 50 carbon atoms, and still more preferably an alkyl group having 1 to 40 carbon atoms. The alkyl group may be linear, branched or cyclic, and preferably a linear or branched alkyl group.

The alkyl group represented by R¹ of Formula (2) may be additionally substituted. The substituent is preferably a polyvinyl group, a polypropylene group, a polystyrene group, a fluorine atom, a chlorine atom, a sulfo group, a phosphonic group, a carboxy group, an alkoxycarbonyl group or an amino or ammonium group which may be substituted, more preferably a polyvinyl group, a polypropylene group, a polystyrene group, a fluorine atom, a sulfo group, a phosphonic group, a carboxy group, an alkoxycarbonyl group, an amino group or an ammonium group, and still more preferably a sulfo group, a phosphonic group or a carboxy group.

In a polyvinyl group, a polypropylene group and a polystyrene group as the substituent, the number of repeating units is preferably from 10 to 100,000, more preferably from 10 to 10,000, and still more preferably, from the viewpoint of viscosity, is from 10 to 5,000.

The aryl group represented by R¹ of Formula (2) is preferably an aryl group having 6 to 60 carbon atoms, more preferably an aryl group having 6 to 30 carbon atoms, still more preferably a phenyl group or a naphthyl group, and still more preferably a phenyl group.

The aryl group represented by R¹ of Formula (2) may be additionally substituted. The substituent is preferably an alkyl group, a halogen atom, a sulfo group or a salt thereof, a phosphonic group, a carboxy group, a halogen atom, a hydroxy group, a heteroaryl group or an amino group which may be substituted, more preferably an alkyl group, a halogen atom, a sulfo group or a salt thereof, a phosphonic group, a carboxy group, a halogen atom or a hydroxy group, and still more preferably an alkyl group, a carboxy group or a hydroxy group. The alkyl group as a substituent of the aryl group represented by R¹ preferably has 1 to 60 carbon atoms, more preferably 1 to 40 carbon atoms, and still more preferably 1 to 30 carbon atoms.

When the R¹ is a phenyl group, the number of substituent(s) thereof is preferably 0 to 5, and more preferably 0 to 4. When R¹ is a phenyl group, while the substituted position(s) of the substituent(s) is not particularly restricted, it is preferably a meta-position or a para-position relative to the carbonyl group of Formula (2).

The heteroaryl group represented by R¹ of Formula (2) has the same definition and the same preferable scope as those of the heteroaryl group represented by R¹ of Formula (1).

The alkoxyl group represented by R¹ of Formula (2) is preferably 1 to 60 carbon atoms, more preferably 1 to 50 carbon atoms, and still more preferably 1 to 40 carbon atoms. The alkoxyl group represented by R¹ of Formula (2) may be additionally substituted. Such substituents include a hydroxy group, a phosphonic group, a sulfo group and a carboxy group.

The aryloxy group represented by R¹ of Formula (2) is preferably an aryloxy group having 6 to 60 carbon atoms, more preferably an aryloxy group having 6 to 50 carbon atoms, and still more preferably a phenyloxy group and a naphthyloxy group. The aryloxy group represented by R¹ of Formula (2) may be additionally substituted. The substituent is preferably a sulfo group, a phosphonic group, a carboxy group or salt thereof, an amino group which may be substituted, an alkyl group, a hydroxy group, an aryl group or a heteroaryl group, and more preferably a sulfo group, a phosphonic group, a carboxy group, an amino group, an ammonium group, a hydroxy group or an alkyl group.

The R² in Formula (2) is preferably a hydrogen atom, an alkyl group, an aryl group or a heteroaryl group, more preferably a hydrogen atom, an alkyl group or an aryl group, and still more preferably a hydrogen atom, an alkyl group or a phenyl group.

The alkyl group represented by R² of Formula (2) is preferably an alkyl group having 1 to 60 carbon atoms, more preferably an alkyl group having 1 to 50 carbon atoms, and still more preferably an alkyl group having 1 to 40 carbon atoms. The alkyl group represented by R² of Formula (2) may be additionally substituted. Such substituents include a hydroxy group, a phosphonic group, a sulfo group and a carboxy group.

The aryl group represented by R² of Formula (2) is preferably an aryl group having 6 to 60 carbon atoms, more preferably an aryl group having 6 to 50 carbon atoms, and still more preferably a phenyl group or a naphthyl group. The aryl group represented by R² of Formula (2) may be additionally substituted. The substituent is preferably a sulfo group, a phosphonic group, a carboxy group or salt thereof, an amino group which may be substituted, an alkyl group, a hydroxy group, an aryl group or a heteroaryl group, and more preferably a sulfo group, a phosphonic group, a carboxy group, an amino group, an ammonium group, a hydroxy group or an alkyl group. The alkyl group as a substituent of the aryl group represented by R² preferably has 1 to 60 carbon atoms, more preferably 1 to 50 carbon atoms, and still more preferably 1 to 40 carbon atoms.

When the R² of Formula (2) is a phenyl group, the number of substituent(s) thereof is preferably 0 to 4, and more preferably 0 to 3. When R² of Formula (2) is a phenyl group, the substituted position(s) of the substituent(s) is not particularly restricted, and preferably a meta-position or a para-position relative to the carbonyl group of Formula (2).

The heteroaryl group represented by R² of Formula (2) has the same definition and the same preferable scope as those of the heteroaryl group represented by R² of Formula (1).

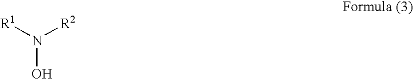

In Formula (3), R¹ and R² each independently represent a hydrogen atom, an alkyl group, an aryl group, a heteroaryl group, an alkoxy group or an aryloxy group, preferably a hydrogen atom, an alkyl group or an aryl group, and more preferably a hydrogen atom, an alkyl group or a phenyl group.

The alkyl group represented by R¹ or R² of Formula (3) is preferably an alkyl group having 1 to 60 carbon atoms, more preferably an alkyl group having 1 to 50 carbon atoms, and still more preferably an alkyl group having 1 to 40 carbon atoms. R¹ and R² may be linked together to form a ring.

The alkyl group represented by R¹ or R² of Formula (3) may be additionally substituted. The substituent is preferably a hydroxy group, a sulfo group, a phosphonic group, a carboxy group, a polyvinyl group, a polypropylene group or a polystyrene group, more preferably a hydroxy group, a sulfo group, a phosphonic group, a carboxy group, an amino group, ammonium, a polyvinyl group, a polypropylene group or a polystyrene group, and still more preferably a hydroxy group, a sulfo group, a phosphonic group or a carboxy group. In a polyvinyl group, a polypropylene group and a polystyrene group as the substituent, the number of repeating units is preferably from 10 to 100,000, more preferably from 10 to 10,000, and still more preferably, from the viewpoint of viscosity, is from 10 to 5,000.

The aryl group represented by R¹ or R² of Formula (3) is preferably an aryl group having 6 to 60 carbon atoms, more preferably an aryl group having 6 to 50 carbon atoms, and still more preferably a phenyl group or a naphthyl group.

The aryl group represented by R¹ or R² of Formula (3) may be additionally substituted. The substituent is preferably a sulfo group, a phosphonic group, a carboxy group, an alkyl group, an aryl group, a hydroxy group, or an amino group which may be substituted, more preferably a sulfo group, a phosphonic group, a carboxy group, an alkyl group or a hydroxy group, still more preferably a sulfo group, a carboxy group or a hydroxy group. The alkyl group as a substituent of the aryl group represented by R² preferably has 1 to 60 carbon atoms, more preferably 1 to 50 carbon atoms, and still more preferably 1 to 40 carbon atoms.

When the R¹ is a phenyl group, the number of substituent(s) thereof is preferably 0 to 5, and more preferably 0 to 4. When R¹ or R² is a phenyl group, the substituted position(s) of the substituent(s) is not particularly restricted, and preferably a para-position relative to the nitrogen atom of Formula (3).

The heteroaryl group represented by R¹ or R² of Formula (3) has the same definition and the same preferable scope as those of the heteroaryl group represented by R² of Formula (1).

The alkoxyl group represented by R¹ or R² of Formula (3) is preferably 1 to 60, more preferably 1 to 50 carbon atoms, and still more preferably 1 to 40 carbon atoms. The alkoxyl group represented by R² of Formula (2) may be additionally substituted. The substituent includes a hydroxy group, a phosphonic group, a sulfo group or a carboxy group.

The aryloxy group represented by R¹ or R² of Formula (3) is preferably an aryloxy group having 6 to 60 carbon atoms, more preferably an aryloxy group having 6 to 50 carbon atoms, and still more preferably a phenyloxy group or a naphthyloxy group. The aryloxy group represented by R² of Formula (3) may be additionally substituted. The substituent is preferably a sulfo group, a phosphonic group, a carboxy group or salt thereof, an amino group which may be substituted, an alkyl group, a hydroxy group, an aryl group or a heteroaryl group, and more preferably a sulfo group, a phosphonic group, a carboxy group, an amino group, an ammonium group, a hydroxy group or an alkyl group.

R¹ and R² may be either the same or different, and preferably a compound in which R¹ is the same as R², from the viewpoint of availability.

—Nitrogen-Containing Heteroring Compound—

As a nitrogen-containing heteroring compound, imidazole, benzimidazole and pyridine are preferred, and compounds represented by the following Formula (IX) being more preferred from the viewpoint of a higher stabilization effect of a doped state.

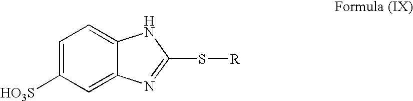

R in Formula (IX) represents an alkyl group, an aryl group or a heteroaryl group, an alkyl group having 1 to 60 carbon atoms being preferred, and an alkyl group having 1 to 40 carbon atoms being more preferred.

An alkyl group represented by R may be further substituted and, as the substituent, a group obtained by removing R in Formula (IX) is preferred.

Specific examples of the acidic compounds and reducing agent used in the present invention are shown below, the acidic compounds and reducing agents of the present invention, however, are not restricted to the specific examples.

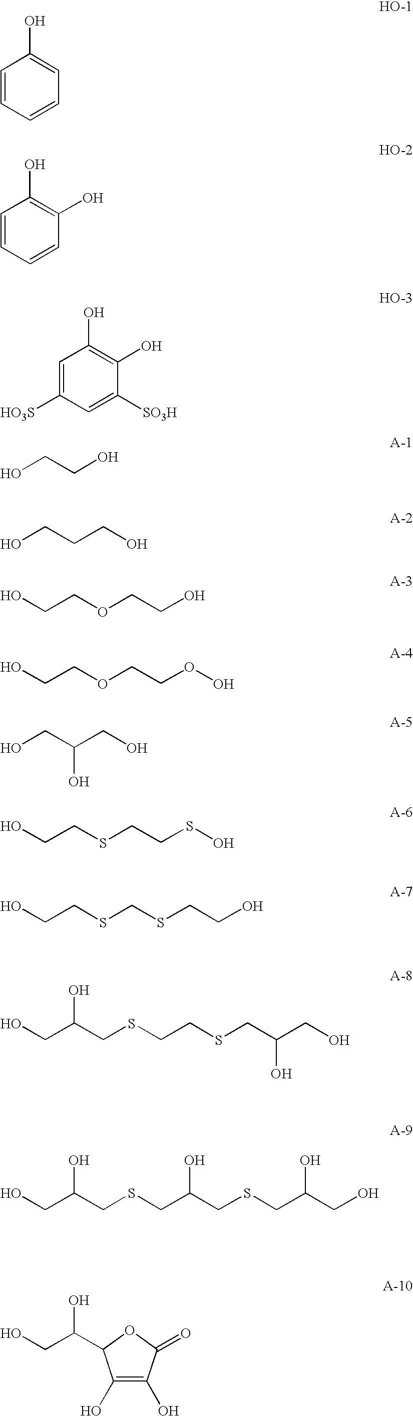

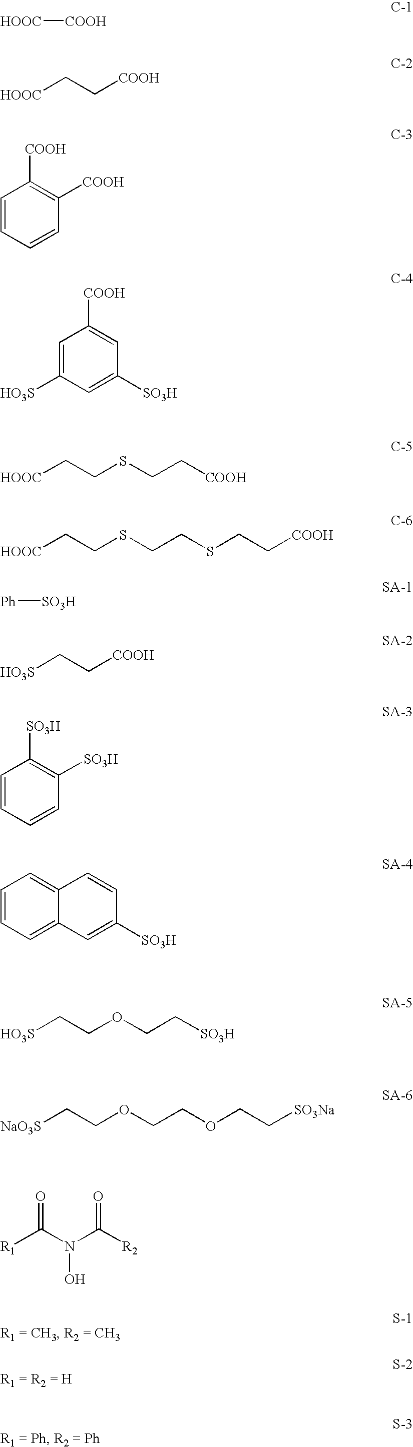

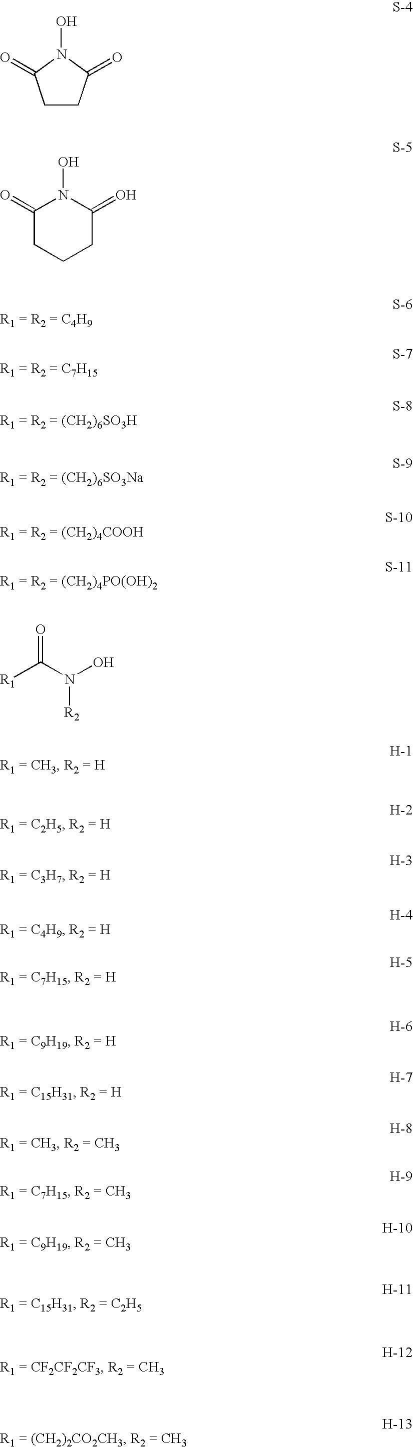

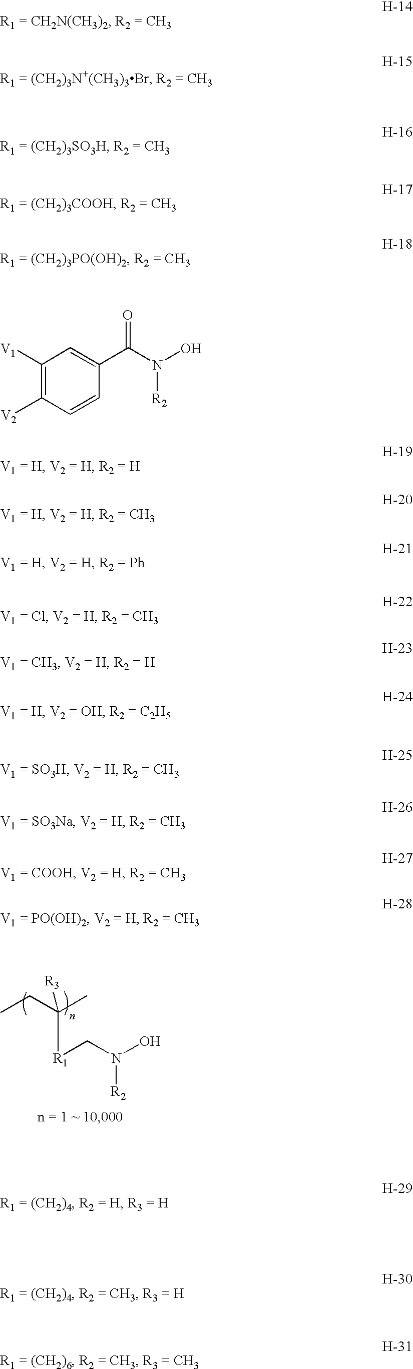

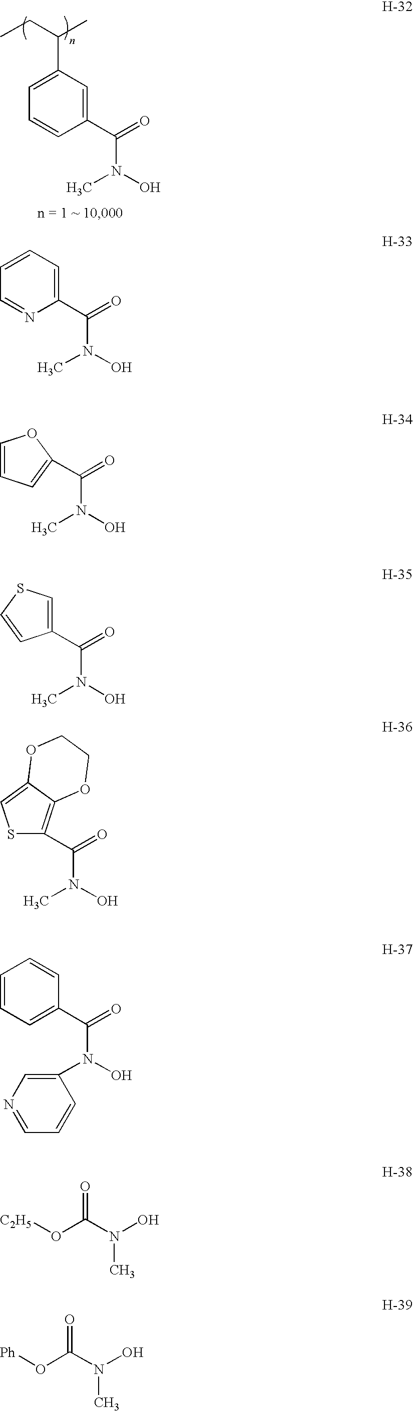

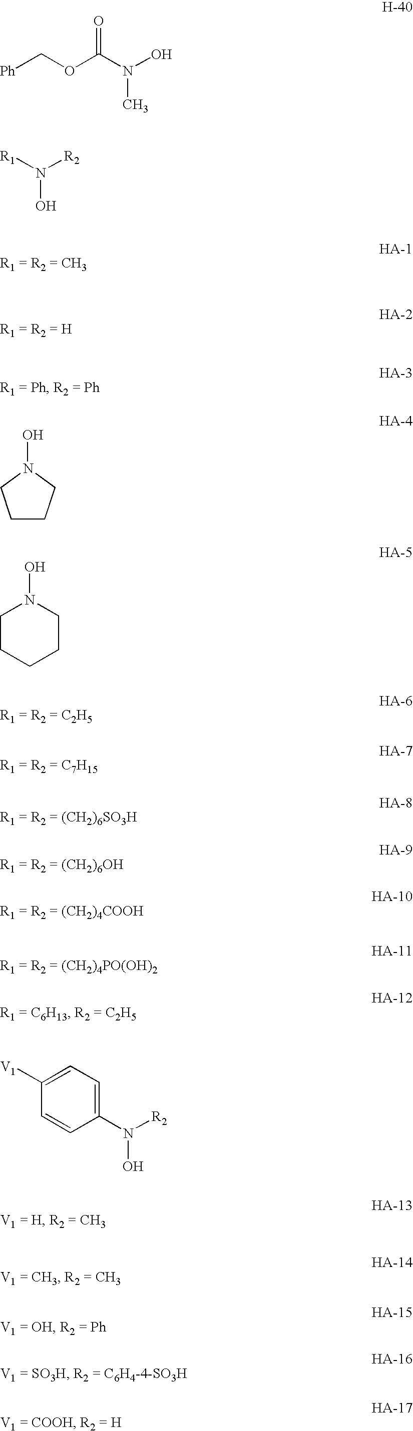

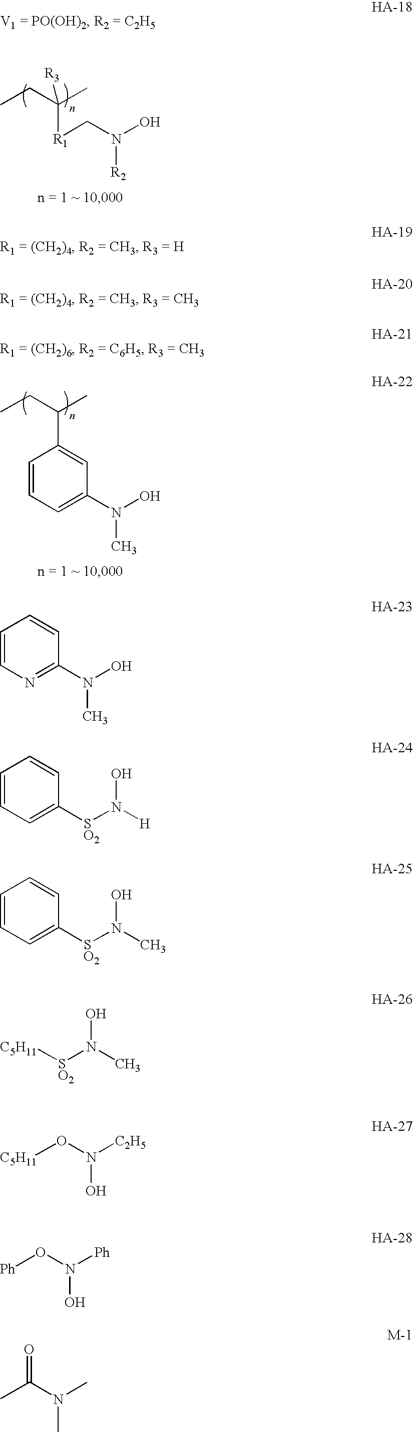

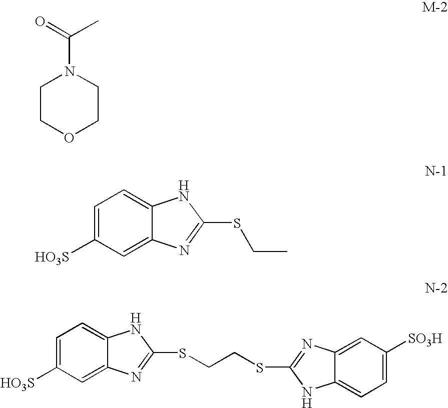

A film thickness of a doped state stabilization layer is not particularly restricted, it is, however, preferably in the range of from 0.01 nm to 1000 μm, more preferably in the range of from 0.1 nm to 100 μm, and still more preferably in the range of from 1 nm to 50 μm. When a film thickness of the doped state stabilization layer is in the range, both of high electroconductivity and high durability are preferably achieved.

An addition amount of the acidic compound or the reducing agent of the present invention is preferably in the range of from 0.000001 g/m² to 100 g/m², more preferably in the range of from 0.00001 g/m² to 10 g/m², and still more preferably in the range of from 0.0001 g/m² to 2 g/m² from the viewpoint of achieving both of high electroconductivity and high durability.

A ratio of the acidic compound or the reducing agent and an electro-conductive polymer of the present invention may have any value. However, the ratio by mass ratio (acidic compound or reducing agent:polymer) is preferably in the range of from 0.00001:1.0 to 1000:1, more preferably in the range of from 0.0001:1.0 to 500:1, and still more preferably in the range of from 0.0005:1.0 to 100:1 from the viewpoint of achieving both of high electroconductivity and high durability.

In the doped state stabilization layer, a solvent described below may be further added, and additives other than the solvent may be still further added. As additives that may be further added, a UV-absorbent, inorganic fine particles, polymer fine particles or a silane coupling agent for improving the film strength, and fluorocompounds (such as fluorosurfactants in particular) for reducing the refractive index to heighten the transparency are cited.

(4) Layer Structure

An electro-conductive polymer material of the present invention is formed by laminating, on or above a support, at least one electro-conductive polymer layer and at least one doped state stabilization layer.

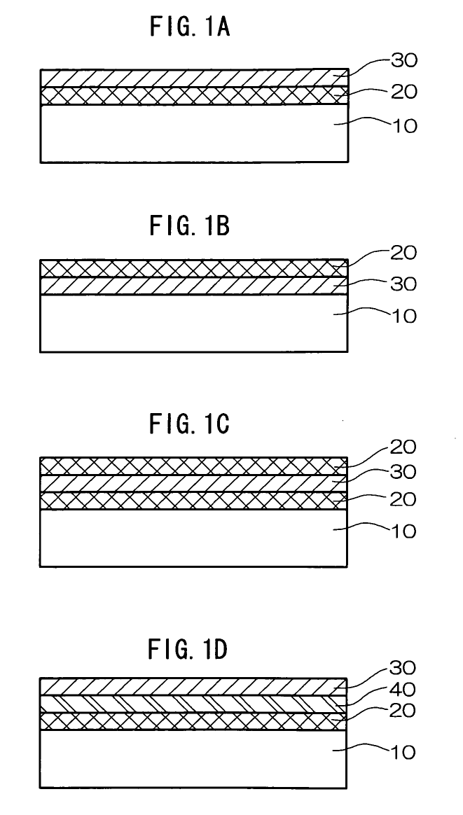

Examples of specific layer structure of the electro-conductive polymer material are shown in FIGS. 1A through 1D.

An electro-conductive polymer material of FIG. 1A is formed by laminating an electro-conductive polymer layer 20 and a doped state stabilization layer 30 on or above a support 10 sequentially from a support side.

An electro-conductive polymer material of FIG. 1B is formed by laminating a doped state stabilization layer 30 and an electro-conductive polymer layer 20 on or above a support 10 sequentially from a support side.

An electro-conductive polymer material of FIG. 1C is formed by laminating three layers of an electro-conductive polymer layer 20, a doped state stabilization layer 30 and another electro-conductive polymer layer 20 on or above a support 10 sequentially from a support side.

An electro-conductive polymer material of FIG. 1D is formed by laminating three layers of an electro-conductive polymer layer 20, an intermediate layer 40, and a doped state stabilization layer 30 on or above a support 10 sequentially from a support side.

An easily adhesive layer (not shown in the drawing) may be formed in order to improve the adhesiveness between the electro-conductive polymer layer 20 or doped state stabilization layer 30 and the support 10. As the easily adhesive layer, a configuration containing a styrene-butadiene copolymer (hereinafter, appropriately, referred to as “SBR”) or an aqueous urethane resin and a crosslinking agent is preferred. The SBR means a copolymer obtained by mainly copolymerizing styrene and butadiene and other component as required. In the copolymer, it is known that, when a content ratio of styrene and butadiene is controlled, copolymers having various physical properties are obtained.

In the case where an easily adhesive layer is formed in the present invention, a styrene-butadiene copolymer is preferably latex. Specifically, commercially available products which are supplied from Nippon Zeon Co., Ltd. under the trade name of NIPOL, from Sumitomo Naugatuck Co., Ltd. under the trade name of NAUGATEX, from Takeda Chemical Industries, Ltd. under the trade name of CROSLENE, from Asahi-Dow Ltd. under the trade name of ASAHI DOW LATEX, and from Dainippon Ink & Chemicals, Inc. and overseas manufacturers may also be used.

A particle of dispersed particles of the latex is preferably 5 μm or less, more preferably 1 μm or less, and still more preferably 0.2 μm or less. When the particle diameter is in the range, particles are difficult to aggregate in a coating step, and the transparency and glossiness of the film are also excellent. When a thickness of a coating layer is required to be thinner, a particle diameter is preferably made smaller accordingly.

Regarding a styrene-butadiene copolymer contained in the easily adhesive layer, a content ratio of styrene/butadiene is preferably substantially from 50/50 to 80/20. A ratio of SBR contained in the latex is preferably from 30% to 50% by mass by solid content.

In the easily adhesive layer, a crosslinking agent is added in order to improve the physical properties of the SBR. As the crosslinking agent, a triazine-based crosslinking agent is preferred.

In the electro-conductive polymer material of the present invention, the doped state stabilization layer 30 and electro-conductive polymer layer 20 may not be formed adjacent with each other as shown in FIG. 1D. However, a case where these are formed adjacent with each other is preferred.

When a trap effect that oxygen is trapped by an acidic compound or reducing agent in a doped state stabilization layer is considered, at least one layer of the doped state stabilization layer 30 is preferably disposed on a side that is farther from a support than the electro-conductive polymer layer 20 as shown in FIGS. 1A, 1C and 1D.

In each of FIGS. 1A˜1D, an electro-conductive polymer material having two or three layers on or above a support is shown. However, the electro-conductive polymer material may have four or more layers.

<Producing Method of Electro-Conductive Polymer Material>

An electro-conductive polymer material of the present invention is formed by laminating an (2) electro-conductive polymer layer and a (3) doped state stabilization layer on or above a (1) support.

An electro-conductive polymer layer and a doped state stabilization layer are formed preferably by coating from the viewpoint of convenience of capable of forming a large area electro-conductive polymer material at one time. Methods other than the coating method include a spin coat method and a transfer method.

A coating solution may be an aqueous dispersion or an organic solvent.

(Electro-Conductive Polymer Layer Coating Solution)

A coating solution for forming an electro-conductive polymer layer (hereinafter, referred to as “electro-conductive polymer layer coating solution”) contains at least the electro-conductive polymer, and a solvent for coating and the dopant are appropriately added depending on situations. Other than these, the above additives that may be added to the electro-conductive polymer layer may be added.

As a solvent of the electro-conductive polymer layer coating solution, water, alcohols, ethers, ketones, esters, hydrocarbons, halogenated hydrocarbons and amides may be used. Water and lower alcohols are preferred from the viewpoint of the cost, and water is preferably used from the viewpoint of environment.

In the case where water is used as a solvent, as a method of dispersing the electro-conductive polymer, known methods may be used. Examples of the dispersing method include a jaw crusher method, an ultra-centrifugal pulverizing method, a cutting mill method, an automatic pestle method, a disc mill method, a ball mill method and an ultrasonic dispersion method.

A concentration of the electro-conductive polymer in the electro-conductive polymer layer coating solution is, desirably controlled appropriately by considering the viscosity or the like, usually preferably from 0.01% to 450% by mass, and more preferably from 0.1% to 10% by mass.

(Doped State Stabilization Layer Coating Solution)

A coating solution for forming a doped state stabilization layer (hereinafter, referred to as “doped state stabilization layer coating solution”) contains at least the acidic compound and/or reducing agent, and a solvent for coating is appropriately added depending on the situation. Other than these, the additives that may be added to the doped state stabilization layer may be added.

As a solvent of the doped state stabilization layer coating solution, water, alcohols, ethers, ketones, esters, hydrocarbons, halogenated hydrocarbons and amides may be used, and water, alcohols, ethers, ketones, esters, hydrocarbons and halogenated hydrocarbons are preferred from the viewpoint of the solubility.

A solvent of the doped state stabilization layer coating solution may be the same as or different from the solvent of the electro-conductive polymer layer coating solution.

A concentration of the acidic compound and/or reducing agent in the doped state stabilization layer coating solution is, desirably controlled considering the viscosity or the like, usually preferably from 0.01% to 50% by mass, and more preferably from 0.1% to 10% by mass.

(Formation of Layer)

Conventional application methods, for example, methods using an extrusion die coater, an air doctor coater, a blade coater, a rod coater, a knife coater, a squeeze coater, a reverse roll coater, a bar coater or the like, may be used as the applying method for applying the electro-conductive polymer layer coating solution and doped state stabilization layer coating solution

When an electro-conductive polymer layer and a doped state stabilization layer are formed, either a method where after one layer is coated, dried, and a next layer is then coated or a method where at least two layers are formed by a simultaneous multilayer coating may be used. The simultaneous multilayer coating is preferred from the viewpoint of reduction of the producing cost and shortening of a producing time. Herein, the “simultaneous multilayer coating” means a coating method where two coating solutions are coated in a state that the liquids are in contact.

The simultaneous multilayer coating is applied by use of a curtain coater, a slide coater, an extrusion coater, or the like. Among these, a curtain coater is preferred.

<Applications>

An electro-conductive polymer material of the present invention may be used preferably in flexible electroluminescence devices (OLEDs), touch screens, organic TFTs, actuators, sensors, electronic papers, flexible light modulators and solar batteries.

As the electro-conductive polymer, transparent materials such as 3,4-ethylenedioxy-polythiophene may be selected; accordingly, the electro-conductive polymer material may be rendered transparent. The transparent electro-conductive polymer material may preferably be used in image display devices such as flexible liquid crystal displays and solar batteries.

The electro-conductive polymer material of the present invention may preferably be used as wirings and electrodes (substrate electrodes) of electronic materials. Since an electro-conductive film may be formed by coating in particular, a large area electro-conductive polymer material is readily produced; accordingly, the electro-conductive polymer material is suitable for applications to substrate electrodes.

### EXAMPLES

In what follows, the present invention will be more specifically described with reference to examples. Materials, reagents, substance amounts and ratios thereof, and operations shown in examples shown below may be appropriately changed as long as these are not deviated from the gist of the present invention. Accordingly, ranges of the present invention are not restricted by the examples shown below.

### Example 1

An aqueous dispersion (trade name: DENATRON P502, manufactured by Nagase Chemtech Co., Ltd.) containing poly(3,4-ethylenedioxy)thiophene and polystyrene sulfonic acid was coated on a PET film by use of a No. 9 bar coater, and dried. A thickness of a resulted layer was 200 nm.

A content of poly(3,4-ethylenedioxy)thiophene in the aqueous dispersion of DENATRON P502 was 3.9% by mass.

A 10% by mass aqueous solution of polyphosphoric acid (manufactured by Tokyo Chemical Industry Co., Ltd.) was then coated thereon with a No. 9 bar coater and dried. A thickness of a layer containing polyphosphoric acid was 1.8 μm.

By estimating from the concentration of the coating solution and the thickness of the formed layer, a mass ratio of poly(3,4-ethylenedioxy)thiophene to polyphosphoric acid was 1:9 and a coating amount of polyphosphoric acid was 1.8 g/m².

The resulted electro-conductive polymer material-1 was evaluated according to methods shown below.

<Measurement of Transmittance>

The transmittance was measured with UV/vis Spectrometer (trade name: Shimadzu U2400, manufactured by Shimadzu Corporation). An electro-conductive polymer material-1 immediately after preparation was measured at four points, and an average value thereof was taken as a measured value. Results are shown in Table 1.

<Measurement of Surface Resistivity>

The surface resistivity was measured with a resistance measuring apparatus (trade name: RORESTA, manufactured by Mitsubishi Chemical Co., Ltd.). The electro-conductive polymer material-1 immediately after preparation was measured at four points, and an average value thereof was taken as a measured value. Results are shown in Table 1.

<Evaluation of Photo-Durability>

The electro-conductive polymer material-1 was irradiated for 80 hr with a xenon lamp light source (150,000 lux) through a UV-cut filter (absorbing 90% of light of 370 nm), and the transmittance and surface resistivity after irradiation were measured according to the above-mentioned methods. Results are shown in Table 1.

<Measurement of Haze>

The haze of the electro-conductive polymer material-I immediately after preparation was measured with a haze measurement meter (trade name: MODEL 1001DP, manufactured by Nippon Denshoku Co., Ltd.). Results are shown in Table 1.

### Examples 2 to 3

Each of electro-conductive polymer materials-2 to 3 was prepared in a manner substantially similar to the example 1 except that a compound shown in Table 1 was added instead of the polyphosphoric acid. The compound shown in Table 1 was added so as to be same in mass with that of polyphosphoric acid added in the example 1. The resulted electro-conductive polymer materials-2 to 3 were evaluated in a manner same as that of example 1. Results are shown in Table 1.

### Example 4

An aqueous dispersion (trade name: DENATRON P502, manufactured by Nagase Chemtech Co., Ltd.) containing poly(3,4-ethylenedioxy)thiophene and polystyrene sulfonic acid was coated on a PET film with a No. 9 bar coater, and dried.

A 10% by mass aqueous solution of polyphosphoric acid (manufactured by Tokyo Chemical Industry Co., Ltd.) was then coated thereon with a No. 9 bar coater, and dried.

Furthermore, an aqueous dispersion (trade name: DENATRON P502, manufactured by Nagase Chemtech Co., Ltd.) containing poly(3,4-ethylenedioxy)thiophene and polystyrene sulfonic acid was coated thereon with a No. 9 bar coater and dried, and thereby an electro-conductive polymer material-4 having a three-layer structure was prepared.

The resulted electro-conductive polymer material-4 was evaluated in a manner same as that of example 1. Results are shown in Table 1.

### Example 5

A 10% by mass aqueous solution of polyphosphoric acid (manufactured by Tokyo Chemical Industry Co., Ltd.) was coated on a PET film with a No. 9 bar coater, and dried.

An aqueous dispersion (trade name: DENATRON P502, manufactured by Nagase Chemtech Co., Ltd.) containing poly(3,4-ethylenedioxy)thiophene and polystyrene sulfonic acid was then coated thereon with a No. 9 bar coater and dried, and thereby an electro-conductive polymer material-5 was prepared.

The resulted electro-conductive polymer material-5 was evaluated in a manner same as that of example 1. Results are shown in Table 1.

### Examples 6 to 8

Electro-conductive polymer materials-6 to 8 were prepared in a manner substantially similar to the example 1 except that aqueous dispersions shown below were used instead of the aqueous dispersion (trade name: DENATRON P502, manufactured by Nagase Chemitech Co., Ltd.), respectively.
(Example 6) Aqueous dispersion of poly(3,4-ethylenedioxy)thiophene/polystyrene sulfonic acid (trade name: BAYTRON P, manufactured by H. C. Starck Inc.)
(Example 7) Aqueous dispersion of poly(3,4-ethylenedioxy)thiophene/polystyrene sulfonic acid (trade name: BAYTRON P-HC V4, manufactured by H. C. Starck Inc.)
(Example 8) Aqueous dispersion of poly(3,4-ethylenedioxy)thiophene/polystyrene sulfonic acid (trade name: BAYTRON P-AG, manufactured by H. C. Starck Inc.)

The resulted electro-conductive polymer materials-6 to 8 were evaluated in a manner same as example 1, and the results shown in Table 1 were obtained.

### Examples 9, 10

Electro-conductive polymer materials-9 and 10 were prepared in a manner substantially similar to the example 1 except that above-exemplified compound C-6 or N-1 was used, respectively, instead of the polyphosphoric acid used in the example 1. Each of the C-6 and N-1 was added so as to be same in mass with polyphosphoric acid added in the example 1.

The resulted electro-conductive polymer materials-9 and 10 were evaluated in a manner same as example 1, and results shown in Table 1 were obtained.

### Examples 11 to 14

Electro-conductive polymer materials-11 to 14 were prepared in a manner substantially similar to the example 1 except that the above-exemplified compounds SA-1, H-6, HA-6 or S-4, respectively, were used instead of the polyphosphoric acid used in the example 1.

The resulted electro-conductive polymer materials-11 to 14 were evaluated in a manner same as example 1, and results shown in Table 1 were obtained.

### Example 15

An electro-conductive polymer material-15 was prepared in a manner substantially similar to the example 1 except that a glass substrate was used instead of the PET substrate.

The resulted electro-conductive polymer material-15 was evaluated in a manner same as example 1, and results shown in Table 1 were obtained.

### Example 16

An aqueous dispersion containing poly(3,4-ethylenedioxy)thiophene and polystyrene sulfonic acid (trade name: Denatron P502, manufactured by Nagase Chemitech Co., Ltd.) and a 10% by mass aqueous solution of polyphosphoric acid (manufactured by Tokyo Chemical Industry Co., Ltd.) were coated on a PET film by use of a simultaneous multi-layer coating method. A layer containing an aqueous dispersion containing poly(3,4-ethylenedioxy)thiophene and polystyrene sulfonic acid and a layer containing a 10% by mass aqueous solution of polyphosphoric acid (manufactured by Tokyo Chemical Industry Co., Ltd.), respectively, were coated and dried so as to be 20 μm before drying.

The resulted electro-conductive polymer material-16 was evaluated in a manner same as example 1, and results shown in Table 1 were obtained.

### Comparative Example 1

When 10% by mass aqueous solution of polyphosphoric acid (manufactured by Tokyo Chemical Industry Co., Ltd.) was added to the same amount of an aqueous dispersion of poly(3,4-ethylenedioxy)thiophene/polystyrene sulfonic acid (trade name: Denatron P502, manufactured by Nagase Chemitech Co., Ltd.), a polymer aggregated. When the solution was coated on a PET film, irregularities were caused. This resulted comparative electro-conductive polymer material-1 was evaluated in a manner same as example 1, and results shown in Table 1 were obtained.

### Comparative Example 2

A coating solution was prepared in a manner substantially similar to comparative example 1 except that A-7 was used, instead of the polyphosphoric acid in comparative example 1.

A comparative electro-conductive polymer material-2 was prepared in a manner substantially similar to the example 1 except that this coating solution was used. The resulted comparative electro-conductive polymer material-2 was evaluated in a manner same as example 1. Evaluation results are shown in Table 1.

### Comparative Example 3

A coating solution was prepared in a manner substantially similar to comparative example 1 except that the polyphosphoric acid in comparative example 1 was changed to HO-3. In this coating solution, polymer particles were observed partially aggregated.

A comparative electro-conductive polymer material-3 was prepared in a manner substantially similar the example 1 except that this coating solution was used. The resulted comparative electro-conductive polymer material-3 was evaluated in a manner same as example 1. Evaluation results are shown in Table 1.

TABLE 1

| | | Before light irradiation | | After light irradiation | | | |
|---|---|---|---|---|---|---|---|
| | | Surface | | Surface | | | |
| | | Resistivity | Transmittance | Resistivity | Transmittance | Haze before | |
| Sample No. | Additive | (Ω/□) | (%) | (Ω/□) | (%) | light irradiation | Layer Structure |
| Example 1 | Polyphosphoric acid | 10,000 | 83 | 14,000 | 82 | 2.0% or less | Lamination (A) |
| Example 2 | A-7 | 11,000 | 83 | 16,000 | 82 | 2.0% or less | Lamination (A) |
| Example 3 | HO-3 | 11,000 | 83 | 16,500 | 82 | 2.0% or less | Lamination (A) |
| Example 4 | Polyphosphoric acid | 11,000 | 83 | 14,000 | 82 | 2.0% or less | Lamination (C) |
| Example 5 | Polyphosphoric acid | 12,000 | 83 | 19,000 | 82 | 2.0% or less | Lamination (B) |
| Example 6 | Polyphosphoric acid | 4,000 | 83 | 5,800 | 82 | 2.0% or less | Lamination (A) |
| Example 7 | Polyphosphoric acid | 1,600 | 83 | 2,000 | 82 | 2.0% or less | Lamination (A) |
| Example 8 | Polyphosphoric acid | 3,000 | 83 | 4,200 | 82 | 2.0% or less | Lamination (A) |
| Example 9 | C-6 | 18,000 | 83 | 22,000 | 82 | 2.0% or less | Lamination (A) |
| Example 10 | N-1 | 12,000 | 83 | 16,000 | 82 | 2.0% or less | Lamination (A) |
| Example 11 | SA-1 | 14,000 | 83 | 20,000 | 82 | 2.0% or less | Lamination (A) |
| Example 12 | H-6 | 12,000 | 83 | 12,000 | 82 | 2.0% or less | Lamination (A) |
| Example 13 | HA-6 | 12,000 | 83 | 15,000 | 82 | 2.0% or less | Lamination (A) |
| Example 14 | S-4 | 12,000 | 83 | 15,000 | 82 | 2.0% or less | Lamination (A) |
| Example 15 | Polyphosphoric acid | 10,000 | 83 | 14,000 | 82 | 2.0% or less | Lamination (A) |
| | | | | | | | Glass substrate |
| Example 16 | Polyphosphoric acid | 12,000 | 83 | 16,000 | 82 | 2.0% or less | Lamination (A) |
| | | | | | | | Simultaneous |
| | | | | | | | multi-layer |
| Comparative | Polyphosphoric acid | 152,000 | 70 | 550,000 | 62 | 13% | Same layer |
| example 1 | | | | | | | |
| Comparative | A-7 | 13,500 | 83 | 21,500 | 82 | 2.0% or less | Same layer |
| example 2 | | | | | | | |
| Comparative | HO-3 | 55,000 | 75 | 108,000 | 65 | 10% | Same layer |
| example 3 | | | | | | | |

In the table shown above, lamination (A), lamination (B), and lamination (C) represent layer structures of FIGS. 1A, 1B, and 1C, respectively.

As obvious from results in Table 1, it is found that, in samples before light irradiation, the electro-conductive polymer materials of examples 1 to 16 are higher in the transmittance, lower in the surface resistivity and smaller in the haze than comparative examples, that is, excellent in the transparency and electroconductivity.

Furthermore, in the examples 1 to 16, the transmittance after light irradiation was a little deteriorated but substantially same as that before light irradiation.

Still furthermore, in the examples 1 to 16, the surface resistivity after irradiating light became little larger compared with that before light irradiation. However, the surface resistivity after light irradiation was increased slightly to an extent that is said hardly changed in comparison with the samples of comparative examples, that is, in a sufficiently practically allowable range. The haze was substantially same before and after light irradiation.

Thus, the electro-conductive polymer materials 1 to 16 are less in the variations of the transmittance and surface resistivity after light irradiation; accordingly, the electro-conductive polymer materials 1 to 16 are found to be excellent in the photo-durability.

On the other hand, in the comparative example 1, the polymer aggregated at the step of preparation of the coating solution, and irregularities occurred in the sample prepared with the coating solution. As the result, in the sample of comparative example 1 before light irradiation, the transmittance was very lower and the surface resistivity was very higher than the examples 1 to 16 and the haze increased (13%).

In the sample of comparative example 1, After light was irradiated, the transmittance was further lowered, the surface resistivity was remarkably increased and the haze was further increased (28%). Accordingly, in the photo-durability as well, the examples 1 to 16 are found to be excellent.

In the comparative example 2, the surface resistivity became very high before and after light irradiation in comparison with the example 2. Accordingly, it is found that the example 2 is superior to the comparative example 2 in the electroconductivity and photo-durability.

In the sample of comparative example 3, before light irradiation, the transmittance was lower, the surface resistivity was higher and the haze increased (10%) than the examples 1 to 16. Furthermore, in the sample of comparative example 3, after light irradiation, the transmittance was further lowered, the surface resistivity was remarkably increased and the haze further increased (25%).

### Example 17

An electro-conductive polymer material-17 was prepared in a manner substantially similar to example 1 except that a dispersion containing 3.0% by mass of polyaniline (manufactured by Aldrich) in xylene was used instead of the aqueous dispersion (trade name: DENATRON P502, manufactured by Nagase Chemitech Co., Ltd.) used in the example 1.

The resulted electro-conductive polymer-17 was evaluated in a manner substantially similar to the example 1. Results are shown in Table 2.

### Comparative Example 4

A comparative sample 4 was prepared in a manner substantially similar to the example 17 except that the layer containing polyphosphoric acid was not disposed. The resulted comparative sample-4 was evaluated in a manner substantially similar to the example 1. Results are shown in Table 2.

TABLE 2

| | | Before light irradiation | | After light irradiation | | | |
|---|---|---|---|---|---|---|---|
| | | Surface | | Surface | | | |
| | Additive | Resistivity | Transmittance | Resistivity | Transmittance | | |
| Sample No. | Polymer kind | (Ω/□) | (%) | (Ω/□) | (%) | Haze | Layer Structure |
| Example 17 | Polyphosphoric acid | 400 | 72 | 580 | 70 | 5% | Lamination (A) |
| | Polyaniline | | | | | | |
| Comparative | Nothing | 460 | 72 | 1120 | 65 | 8% | Single layer |
| example 4 | Polyaniline | | | | | | |

### Example 18

### (Production of Touch Panel Device)

A substrate was prepared by depositing indium tin oxide on a glass substrate, a dot spacer having a thickness of 4 μm (trade name: RESIST CR-103C, manufactured by Toyobo Co., Ltd.) was formed by photolithography, thereafter a wiring was formed with a silver paste (trade name: DW-250H-5, manufactured by Toyobo Co., Ltd.) by means of a screen printing method. Furthermore, an insulating portion was formed with an insulating ink (trade name: JELCON IN, manufactured by Jyujyo Chemical). Finally, the electro-conductive polymer material-1 prepared in the example 1 was bonded thereto, and, thereby a touch panel device was prepared.

(Evaluation of Touch Panel Device)

When the touch panel device was operated under condition where outdoor light was incident, it was found that excellent touch panel characteristics were exhibited. That is, it was confirmed that the touch panel device formed from the electro-conductive composition of the present invention was high in the durability to light.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

All publications, patent applications, and technical standards mentioned in this specification are herein incorporated by reference to the same extent as if each individual publication, patent application, or technical standard was specifically and individually indicated to be incorporated by reference.

What is claimed is:

1. An electro-conductive polymer material, comprising:
a support;
at least one layer containing an electro-conductive polymer; and
at least one layer containing at least one selected from an acidic compound or a reducing agent,
wherein the at least one layer containing an electro-conductive polymer and the at least one layer containing at least one selected from an acidic compound or a reducing agent are formed on or above the support.

2. The electro-conductive polymer material according to claim 1, wherein the electro-conductive polymer is at least one polymer selected from polythiophene or a derivative thereof.

3. The electro-conductive polymer material according to claim 2, wherein the electro-conductive polymer includes poly(3,4-ethylenedioxy)thiophene.

4. The electro-conductive polymer material according to claim 2, wherein the layer containing the electro-conductive polymer further contains polystyrene sulfonic acid.

5. The electro-conductive polymer material according to claim 1, wherein the acidic compound includes at least one compound selected from the group consisting of polyphosphoric acid, a hydroxy compound, a carboxy compound and a sulfonic acid compound.

6. The electro-conductive polymer material according to claim 5, wherein the polyphosphoric acid includes at least one compound selected from the group consisting of diphosphoric acid, pyrophosphoric acid, triphosphoric acid and polyphosphoric acid.

7. The electro-conductive polymer material according to claim 5, wherein the hydroxy compound is a compound represented by the following Formula (II): 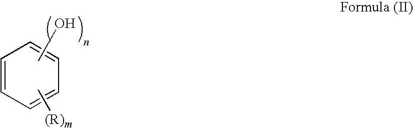
wherein in Formula (II), R represents a sulfo group, a halogen atom, an alkyl group, an aryl group, a carboxy group or an alkoxycarbonyl group; n is from 1 to 6; and m is from 0 to 5.

8. The electro-conductive polymer material according to claim 5, wherein the carboxy compound is a compound represented by the following Formula (III) or (IV):
HOOC-A-COOH Formula (III)
wherein in Formula (III), A represents a single bond or a divalent linking group, 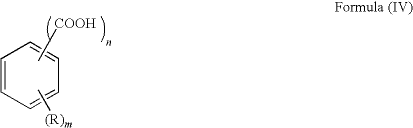
wherein in Formula (IV), R represents a sulfo group, a halogen atom, an alkyl group, an aryl group, a hydroxy group or an alkoxycarbonyl group; n is from 1 to 6; and m is from 0 to 5.

9. The electro-conductive polymer material according to claim 5, wherein the sulfonic acid compound is a sulfonic acid compound substituted with an aryl group or an alkyl group.

10. The electro-conductive polymer material according to claim 1, wherein the reducing agent includes at least one compound selected from the group consisting of a thioether compound, a succinimide compound, a polyol compound, a hydroxamic acid compound and a hydroxyamine compound.

11. The electro-conductive polymer material according to claim 10, wherein the thioether compound is a compound having any one of the following thioether structures:

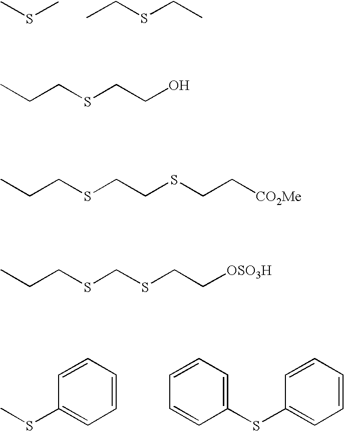

12. The electro-conductive polymer material according to claim 10, wherein the succinimide compound is a compound represented by the following Formula (V): 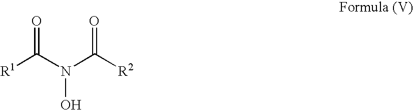
wherein in Formula (V), R¹ and R² each independently represent a hydrogen atom, an alkyl group, an aryl group, a heteroaryl group, a polyvinyl group, a polypropylene group or a polystyrene group.

13. The electro-conductive polymer material according to claim 10, wherein the polyol compound is a compound represented by the following Formula (VIII):
HO-A-OH Formula (VIII)
wherein in Formula (VIII), A represents a divalent linking group.

14. The electro-conductive polymer material according to claim 10, wherein the hydroxamic acid compound is a compound represented by the following Formula (2): 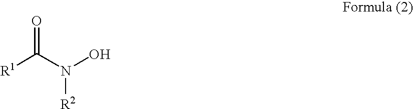
wherein in Formula (2), R¹ represents a hydrogen atom, an alkyl group, an aryl group, a heteroaryl group, an alkoxy group or an aryloxy group; and R² represents a hydrogen atom, an alkyl group, an aryl group or a heteroaryl group.

15. The electro-conductive polymer material according to claim 10, wherein the hydroxyamine compound is a compound represented by the following Formula (3): 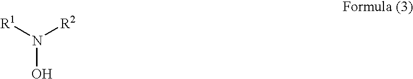
wherein in Formula (3), R¹ and R² each independently represent a hydrogen atom, an alkyl group, an aryl group, a heteroaryl group, an alkoxy group or an aryloxy group.

16. The electro-conductive polymer material according to claim 1, wherein the layer containing at least one selected from an acidic compound or a reducing agent is disposed on a side that is farther from the support than the layer containing the electro-conductive polymer.

17. The electro-conductive polymer material according to claim 1, wherein an addition amount of at least one selected from the acidic compound or reducing agent is from 0.00001 g/m²to 10 g/m².

18. The electro-conductive polymer material according to claim 1, wherein a ratio of at least one selected from the acidic compound or reducing agent to the electro-conductive polymer ((at least one selected from acidic compound or reducing agent):(electro-conductive polymer)) is in the range of from 0.0001:1.0 to 500:1 by mass ratio.

19. An electrode material comprising the electro-conductive polymer material according to claim 1.

20. A producing method of the electro-conductive polymer material according to claim 1, the method comprising forming at least two layers among the layer(s) containing an electro-conductive polymer and the layer(s) containing at least one selected from an acidic compound or a reducing agent by simultaneous multilayer coating.
